(19) United States
(12) Patent Application Publication
(10) Pub. No.: US 2006/0017834 A1
(43) Pub. Date: Jan. 26, 2006

(54) Imaging optical system and imaging lens device

(75) Inventors: Kenji Konno, Sakai-shi (JP); Soh Ohzawa, Toyonaka-shi (JP); Jun Ishihara, Kobe-shi (JP); Mitsuaki Shimo, Osaka-shi (JP); Hiroshi Kibayashi, Niiza-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA OPTO, INC.

(21) Appl. No.: 11/186,186

(22) Filed: Jul. 21, 2005

(30) Foreign Application Priority Data
Jul. 23, 2004 (JP) 2004-216517
Oct. 29, 2004 (JP) 2004-315771
Feb. 15, 2005 (JP) 2005-38323
Feb. 17, 2005 (JP) 2005-41203

(51) Int. Cl. H04N 5/225

(52) U.S. Cl. 348/335

(57) ABSTRACT

An imaging optical system 100 has an imaging side prism 102 for bending incident light at about 90 degrees for reflection, and an image sensor 105 having a light receiving surface opposing to an exit surface 102b of the imaging side prism 102. At least one of an incident surface 101a of an incident side prism 101 and an incident surface 101a of the imaging side prism 102, or at least one of an exit surface 101b of the incident side prism 101 and the exit surface 102b of the imaging side prism 102 has an optical power. An arrangement relation between the exit surface 102b of the imaging side prism 102 and the image sensor 105 is established to satisfy the conditional formula (1):
0.0≦d/a<0.8 (1)
where d represents a distance between the exit surface 102b and the light receiving surface of the image sensor 105, and a represents a height of the light receiving surface of the image sensor 105 on a plane where an optical path of the imaging optical system 100 is folded, e.g., the size of the image sensor 105 in the shorter side direction thereof. This arrangement enables to reduce the thickness of an apparatus housing BD for incorporating the imaging optical system 100.

This application is based on Japanese Patent Application Nos. 2004-216517, 2004-315771, 2005-38323, and 2005-41203 respectively filed on Jul. 23, 2004, Oct. 29, 2004, Feb. 15, 2005, and Feb. 17, 2005 the contents of which are hereby incorporated by reference.

### BACKGROUND OF THE INVENTION

1. Field of the Invention

The present invention relates to an imaging optical system, and an imaging lens device incorporated with the imaging optical system.

2. Description of the Related Art

In recent years, with an explosive spread of digital apparatuses such as a digital still camera, a digital video camera, a mobile phone with a built-in camera (hereinafter, called as “camera phone”), and a personal digital assistant (PDA), development of a high-resolution or sophisticated image sensor to be loaded in these digital apparatuses has been rapidly progressed. In view of this, high optical performance is demanded for an imaging optical system for guiding an optical image of a subject to an image sensor in order to sufficiently utilize the performance of the high-resolution image sensor.

In addition to the above, portability is required in each of the digital apparatuses. There is proposed miniaturization of the imaging optical system as one measure for miniaturization of the digital apparatus. Conventionally, a collapsible mechanism has been adopted in the imaging optical system as one measure for miniaturization of the imaging optical system, for instance.

In the imaging optical system adopting the collapsible mechanism, the construction of a lens barrel is complicated, which may give rise to cost increase. Particularly, in a mechanism constructed such that a lens unit pops out in response to turning on of the power of the digital apparatus, it takes a certain time to finalize a shooting preparatory operation. Accordingly, a user may fail to release the shutter at a right moment to capture a scene.

There is known a technique of eliminating a reflecting surface on an optical path of an imaging optical system, as another measure for miniaturizing the imaging optical system. Various arrangements have been proposed in the imaging optical system. For instance, Japanese Unexamined Patent Publication No. 2002-196243 or counterpart U.S. Pat. No. 6,671,099B2 (called as “D1”) recites an imaging optical system provided with a first prism and a second prism each made of a medium having a refractive index of larger than 1.3, wherein the optical system comprises, in the order from the object side, a front unit including the first prism, an aperture stop, and a rear unit including the second prism, and the optical system is constructed not to form an intermediate image. Japanese Unexamined Patent Publication No. 2000-171716 (called as “D2”) proposes an imaging optical system having a reflecting surface, wherein an optical path is folded for the purpose of producing a compact and thin optical system. Japanese Unexamined Patent Publication No. HEI 9-211331 (called as “D3”) discloses an optical system provided with an optical device, wherein the optical system comprises, in the order of propagating an incident ray from an object, a first refracting surface serving as an incident surface, a convex mirror inclined relative to a reference axis of the first refracting surface, a concave mirror which serves as a second reflecting surface and is inclined relative to the reference axis, and a second refracting surface having a negative optical power.

Further, Japanese Unexamined Patent Publication No. 2004-70235 (called as “D4”) discloses an imaging optical system, wherein an optical axis is bent by 90 degrees by fixedly arranging a triangular prism in a lens group closest to an object or a subject, and a surface of the triangular prism for passing incident light is an aspherical concave surface. Japanese Unexamined Patent Publication No. 2004-170707 or counterpart U.S. patent application Publication No. 2004/0095503A1 (called as “D5”) discloses a technique of miniaturizing an imaging optical system by providing two reflecting surfaces for bending an optical axis by 90 degrees, wherein the bending direction is “twisted” in the space. Japanese PCT Publication (tokuhyo) 2000-515255 or counterpart U.S. Pat. No. 6,850,279B1 (called as “D6”) discloses a technique of miniaturizing an optical system by providing two reflecting elements, namely, mirrors for bending an optical axis by 90 degrees in a fixed focal length optical system. Japanese Unexamined Patent Publication No. 2004-247887 (called as “D7”) discloses a technique of miniaturizing an optical system by providing two reflecting elements such as a triangular prism or a mirror for bending an optical axis by 90 degrees.

In the documents D1 through D7, the following points should be considered. Specifically, in the imaging optical system recited in D1, all the prisms are decentered optical systems having an optical power on a reflecting surface thereof. Decentered aberrations are likely to occur in a decentered optical system unlike an axially symmetrical optical system. Accordingly, a conventional facility for use in production and evaluation of axially symmetrical optical systems cannot be used for a decentered optical system, and a new facility is required. Further, since a multitude of aberrations to be corrected occur in the decentered optical system, it is extremely difficult to produce an imaging optical system based on the decentered optical system. In addition to this, since the decentered optical system has two reflecting surfaces in each of which an error sensitivity due to its decentering is theoretically assumed to be about 4 times as high as a refractive optical system, high positional precision is required on these two reflecting surfaces.

In the imaging optical system recited in D2, the image sensor is arranged at a specified position in an attempt to produce a thin imaging optical system. Generally, it is difficult to produce a thin imaging optical system because a sufficient space is required for a wiring or the like to be provided in the vicinity of an image sensor.

Similarly to the imaging optical system recited in D1, the imaging optical system recited in D3 involves difficulty in production of a prism. Further, since merely a single reflecting prism having two reflecting surfaces is provided in the imaging optical system in D3, the optical system has difficulty in compatibility with an image sensor having several million pixels, although it has an optical performance compatible with an image sensor of several hundred thousand pixels.

In the imaging optical system recited in D4, since the optical axis is bent once, the thickness of the camera incorporated with the imaging optical system is determined by the size of the image sensor. Generally, parts such as a wiring, a circuit, and a packaging unit are arranged in the periphery of a light receiving surface of an image sensor, and the areas of these parts are considerably large as compared with the area of the light receiving surface. Therefore, the arrangement of D4 needs further improvement for miniaturization.

The zoom optical system recited in D5 has two reflecting surfaces for bending the optical axis by 90 degrees. However, the bending direction is “twisted” in the space. Accordingly, as in the case of D4, the thickness of the camera loaded with the optical system is determined by the size of the image sensor, and the arrangement of D5 needs further improvement for miniaturization.

In the optical system recited in D6, the thickness of the camera is determined by the thickness of the optical system. However, since the optical axis is bent by using a reflecting mirror, the required optical path is long as compared with the case of using a prism. As a result, the thickness of the optical system at a portion where the optical axis is bent is increased.

Further, although a prism is used for bending the optical axis in the optical system recited in D7, the prism is a triangular prism of a simple construction. Further, since a lens element is provided on the object side outside of the prism, the arrangement of D7 needs further improvement for miniaturization.

As mentioned above, the optical systems disclosed in D1 through D7 may lead to cost rise, and production of a compact imaging optical system having a high performance is difficult. In addition to these drawbacks, D4 through 7 are silent about a point that an arrangement relation between an exit surface of a reflecting prism and a light receiving surface of an image sensor is essentially important in miniaturizing an optical system provided with a reflecting prism, as shown in the arrangements of D4 through D7.

### SUMMARY OF THE INVENTION

It is an object of the present invention to provide an imaging optical system and an imaging lens device which are free from the problems residing in the prior art.

It is another object of the present invention to provide an imaging optical system which is inexpensive and compact, and has a high optical performance, and is loadable in a thin mobile phone or a thin personal digital assistant by optimizing an arrangement relation between an exit surface of a reflecting prism and a light receiving surface of an image sensor, and an imaging lens device incorporated with such imaging optical system.

According to an aspect of the invention, an imaging optical system forms an optical image of a subject on a light receiving surface of an image sensor for converting the optical image into electrical signals. The imaging optical system is provided with two reflecting prisms each of which is adapted to bend incident light at a predetermined angle for reflection. An incident surface of the reflecting prism disposed on the side of the subject on an optical path, and an exit surface of the other reflecting prism are aligned substantially parallel to each other. The incident surface or the exit surface of the at least one of the reflecting prisms has an optical power.

In this imaging optical system, the two reflecting prisms each adapted for bending the incident light at the predetermined angle for reflection are arranged in such a manner that the incident surface of the reflecting prism disposed on the subject side on the optical path, and the exit surface of the other reflecting prism are aligned substantially parallel to each other. This arrangement enables to provide an inexpensive and compact imaging optical system.

Another aspect of the invention is directed to an imaging optical system comprising: a reflecting prism which reflects incident light at about 90 degrees; and an image sensor which has a light receiving surface opposing to an exit surface of the reflecting prism, and converts an optical image of a subject into electrical signals, wherein an arrangement relation between the exit surface of the reflecting prism and the light receiving surface of the image sensor satisfies the conditional formula (1):
0.0≦d/a<0.8 (1)
where a represents a height of the light receiving surface of the image sensor on a plane where an optical path of the imaging optical system is folded, and d represents a distance between the exit surface of the reflecting prism and the light receiving surface of the image sensor, the distance d including a physical distance in a case that an optical component is provided between the exit surface of the reflecting prism and the light receiving surface of the image sensor.

In this imaging optical system, the arrangement relation between the exit surface of the reflecting prism and the light receiving surface of the image sensor is optimized to miniaturize the imaging optical system incorporated with the image sensor. This arrangement enables to provide a thin digital apparatus incorporated with the imaging optical system.

These and other objects, features and advantages of the present invention will become more apparent upon reading of the following detailed description along with the accompanying drawings.

### BRIEF DESCRIPTION OF THE DRAWINGS

FIGS. 1A and 1B are cross-sectional views schematically each showing FIG. 1A shows an imaging optical system incorporated with two reflecting prisms, and FIG. 1B shows an imaging optical system incorporated with a single reflecting prism which opposes a light receiving surface of an image sensor.

FIG. 2 is an illustration explaining an exit pupil distance.

FIGS. 3A and 3B are optical path diagrams each showing a relation between an incident side prism and a light ray, wherein FIG. 3A shows a prism which does not have an optical power, and FIG. 3B shows a prism having an optical power.

FIGS. 4A and 4B are cross-sectional views each showing an imaging side prism provided with an infrared cutting function, wherein FIG. 4A shows an example that an infrared reflecting film is integrally formed on an exit surface of an imaging side prism, and FIG. 4B shows an example that an infrared absorbing film is integrally formed on a reflecting surface of an imaging side prism.

FIG. 5 is a perspective view depicting the imaging optical system shown in FIG. 1A in a stereoscopic manner.

FIG. 6 is a schematic optical path diagram of the imaging optical system shown in FIG. 5.

FIG. 7 is a cross-sectional view schematically showing an arrangement of a zoom optical system as another embodiment of the imaging optical system embodying the invention.

FIGS. 8A through 8C are external schematic views each showing a camera phone loaded with the inventive imaging optical system or the inventive zoom optical system, wherein FIG. 8A shows an external appearance of an operating face of the camera phone loaded with the imaging optical system, FIG. 8B shows an external appearance of a back face of the camera phone loaded with the imaging optical system is loaded, and FIG. 8C shows an external appearance of the camera phone loaded with the zoom optical system.

FIGS. 9A and 9B are external schematic views each showing a foldable camera phone, wherein FIG. 9A shows an external appearance of an operating face of the camera phone, and FIG. 9B shows an external appearance of a back face of the camera phone.

FIGS. 10A and 10B are external schematic views each showing a portable digital assistant, wherein FIG. 10A shows an external appearance of an operating face of the portable digital assistant, and FIG. 10B shows an external appearance of a back face of the portable digital assistant.

FIG. 11 is an illustration showing an arrangement of optical devices in a first embodiment of the inventive imaging optical system with an infinite focal length.

FIG. 12 is an illustration showing an arrangement of an imaging optical system, wherein a lens element having a function substantially equivalent to the function of a reflecting prism shown in FIG. 11 is used in place of the reflecting prism.

FIG. 13 is an illustration showing an arrangement of an imaging optical system, wherein a prism is provided in place of the lens element disposed on the object side on the optical path in FIG. 12.

FIG. 14 is an illustration showing an arrangement of optical devices in a second embodiment of the inventive imaging optical system with an infinite focal length.

FIG. 15 is an illustration showing an arrangement of an imaging optical system, wherein a lens element having a function substantially equivalent to the function of a reflecting prism shown in FIG. 14 is used in place of the reflecting prism.

FIG. 16 is an illustration showing an arrangement of optical devices in a third embodiment of the inventive imaging optical system with an infinite focal length.

FIG. 17 is an illustration showing an arrangement of an imaging optical system, wherein a lens element having a function substantially equivalent to the function of a reflecting prism shown in FIG. 16 is used in place of the reflecting prism.

FIGS. 18A through 18F are aberration diagrams regarding spherical aberrations, astigmatisms, and distortion aberrations of lens groups in the imaging optical system in accordance with the first embodiment.

FIGS. 19A through 19F are aberration diagrams regarding spherical aberrations, astigmatisms, and distortion aberrations of lens groups in the imaging optical system in accordance with the second embodiment.

FIGS. 20A through 20F are aberration diagrams regarding spherical aberrations, astigmatisms, and distortion aberrations of lens groups in the imaging optical system in accordance with the third embodiment.

FIG. 21 is a cross-sectional view of a fourth embodiment of the imaging optical system, namely, a zoom optical system taken along a longitudinal direction of an optical axis in FIG. 21.

FIG. 22 is a cross-sectional view of a zoom optical system taken along a longitudinal direction of an optical axis shown in FIG. 22, wherein a lens element having a function substantially equivalent to the function of a reflecting prism in

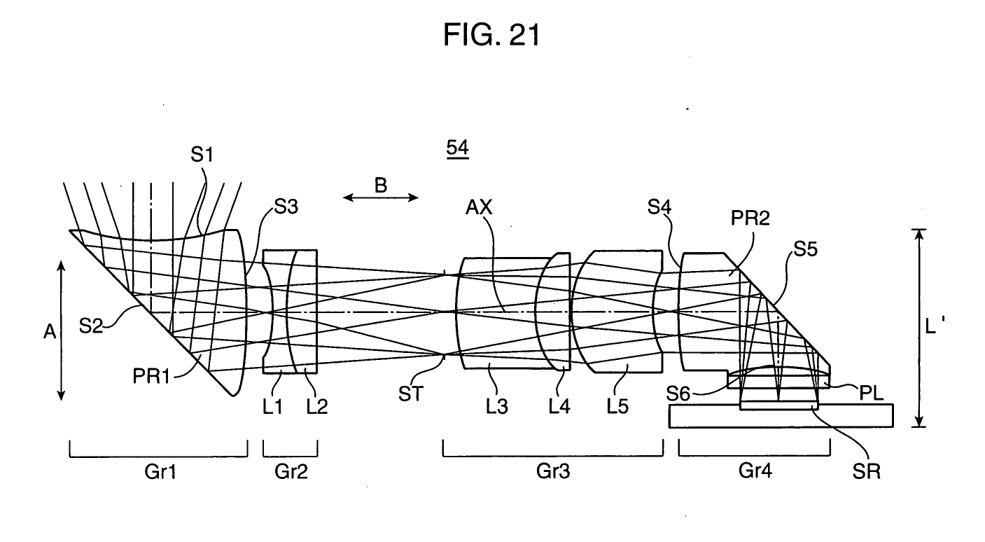

FIG. 21 is used in place of the reflecting prism.

FIG. 23 is a cross-sectional view of a fifth embodiment of the imaging optical system, namely, a zoom optical system taken along a longitudinal direction of an optical axis in FIG. 23.

FIG. 24 is a cross-sectional view of a zoom optical system taken along a longitudinal direction of an optical axis shown in FIG. 24, wherein a lens element having a function substantially equivalent to the function of a reflecting prism in

FIG. 23 is used in place of the reflecting prism.

FIG. 25 is a cross-sectional view of a sixth embodiment of the imaging optical system, namely, a zoom optical system taken along a longitudinal direction of an optical axis in FIG. 25.

FIG. 26 is a cross-sectional view of a zoom optical system taken along a longitudinal direction of an optical axis shown in FIG. 26, wherein a lens element having a function substantially equivalent to the function of a reflecting prism in FIG. 25 is used in place of the reflecting prism.

FIGS. 27A through 27I are aberration diagrams regarding spherical aberrations, astigmatisms, and distortion aberrations of lens groups in the zoom optical system in accordance with the fourth embodiment with an infinite focal length.

FIGS. 28A through 28I are aberration diagrams regarding spherical aberrations, astigmatisms, and distortion aberrations of lens groups in the zoom optical system in accordance with the fifth embodiment with an infinite focal length.

FIGS. 29A through 29I are aberration diagrams regarding spherical aberrations, astigmatisms, and distortion aberrations of lens groups in the zoom optical system in accordance with the sixth embodiment with an infinite focal length.

FIGS. 30A through 30I are aberration diagrams regarding spherical aberrations, astigmatisms, and distortion aberrations of lens groups in the zoom optical system in accordance with the sixth embodiment with a closest focal length.

### DETAILED DESCRIPTION OF THE PREFERRED EMBODIMENTS OF THE INVENTION

### Description on Arrangement of Imaging Optical System

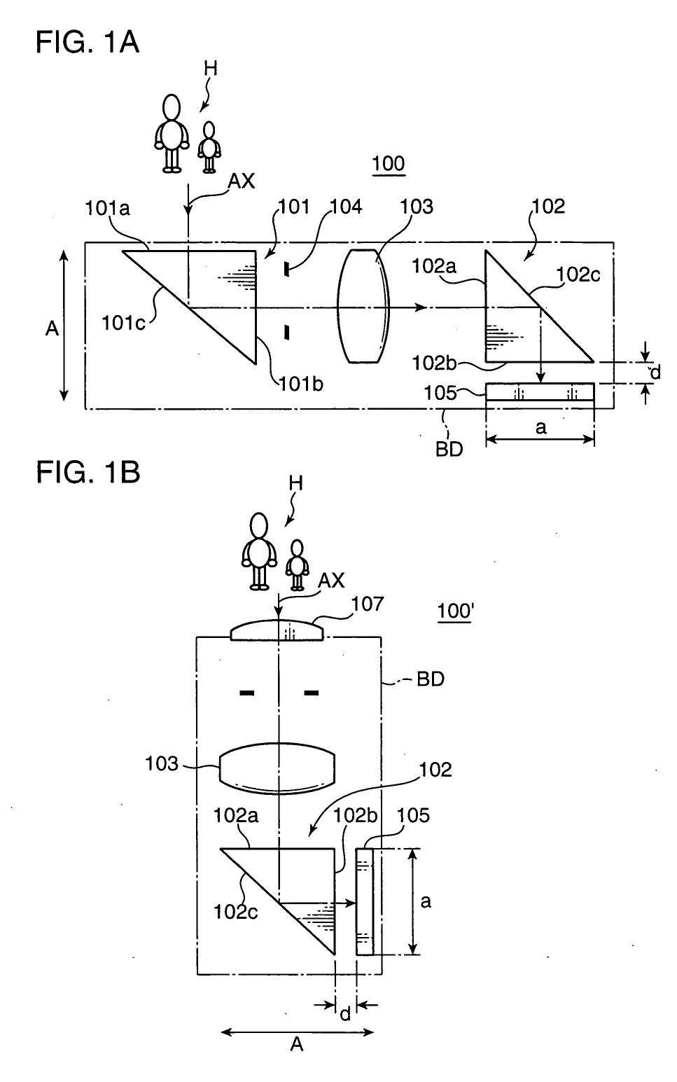

FIG. 1A is an illustration schematically showing an arrangement of an imaging optical system 100 embodying the invention. The imaging optical system 100 is adapted to form an optical image of a subject H on a light receiving surface of an image sensor 105 which converts the optical image into electrical signals. The imaging optical system 100 has two reflecting prisms each adapted to bend an incident ray at a certain degree, e.g., about 90 degrees, for guiding the reflected ray in a predetermined direction. Specifically, the imaging optical system 100 has a first reflecting prism 101 disposed on the side of the subject H on the optical path (hereinafter, also called as “incident side prism 101”), and a second reflecting prism 102 disposed on the side of the image sensor 105 on the optical path (hereinafter, also called as “imaging side prism 102”). A lens element 103 for focusing, and an aperture stop 104 are arranged between the incident side prism 101 and the imaging side prism 102 according to needs.

An incident surface 101a of the incident side prism 101 and an exit surface 102b of the imaging side prism 102 are disposed substantially parallel to each other. Specifically, an optical axis AX from the subject H to the image sensor 105 is bent on a reflecting surface 101c of the incident side prism 101 at about 90 degrees, and then bent on a reflecting surface 102c of the imaging side prism 102 at about 90 degrees. The imaging optical system 100 is housed in an apparatus housing BD of a variety of digital apparatuses such as a mobile phone.

In the imaging optical system 100 having the above construction, at least one of the incident surface 101a of the incident side prism 101 and an incident surface 102a of the imaging side prism 102, or at least one of an exit surface 101b of the incident side prism 101 and the exit surface 102b of the imaging side prism 102 has an optical power. For instance, the incident surface 101a or the exit surface 101b of the incident side prism 101, and/or the incident surface 102a or the exit surface 102b of the imaging side prism 102 has an optical power. Alternatively, the incident surface 101a of the incident side prism 101 and the incident surface 102a of the imaging side prism 102, or the exit surface 101b of the imaging side prism 101 and the exit surface 102b of the imaging side prism 102 may have an optical power. In any of the arrangements, at least one of the incident surfaces 101a, 102a, or at least one of the exit surfaces 101b, 102b is utilized as a surface having a function of a lens element. Accordingly, this arrangement enables to obviate use of an additional optical device, which contributes to production of a compact imaging optical system.

The image sensor 105 photoelectrically converts an optical image of the subject H formed by the imaging optical system 100 into image signals of red (R), green (G), and blue (B) components in accordance with the light amount of the optical image for outputting the image signals to a specified image processing circuit. An example of the image sensor 105 is a single CCD color area sensor of a so-called “Bayer matrix” in which patches of color filters each in red (R), green (G), and blue (B) are attached on respective surfaces of charge coupled devices (CCDs) arrayed in two dimensions. A CMOS image sensor, a VMIS® image sensor produced by Innotech Corporation, and a like sensor are usable as the image sensor in addition to the CCD color area sensor.

In the case where the image sensor 105 is of a rectangular shape having a longer side and a shorter side, it is preferable that a light ray is bent in the shorter side direction of the image sensor 105, namely, in the direction of the arrows a in FIG. 1A. It is possible to reduce the thickness of the imaging optical system 100 to some extent by bending a light ray in the longer side direction of the image sensor 105. However, designing the optical system in such a manner as to bend a light ray in the shorter side direction of the image sensor 105 is advantageous in producing a thin imaging optical system.

In the imaging optical system 100 having the above construction, an arrangement relation between the exit surface 102b of the imaging side prism 102 and the light receiving surface of the image sensor 105 is optimized. Specifically, in FIG. 1A, the size of the imaging optical system 100 in the direction of the arrows A can be reduced by matching the moving direction of the focusing lens element 103 and the arranged direction of an image sensor holder (not shown) including the image sensor 105 which requires a certain width, with the widthwise direction of the apparatus housing BD. However, in the arrangement that the image sensor 105 is housed in the apparatus housing BD with the exit surface 102b of the imaging side prism 102 opposing to the image sensor 105, it is desirable to minimize the distance between the exit surface 102b of the imaging side prism 102 and the image sensor 105 to reduce the thickness of the apparatus housing BD.

Now, let us assume that d represents a distance between the exit surface 102b of the imaging side prism 102 and the light receiving surface of the image sensor 105, the distance d including a physical distance in a case that an optical component is arranged between the imaging side prism 102 and the image sensor 105, and a represents a height of the light receiving surface of the image sensor 105 on a plane where the optical path of the imaging optical system 100 is folded, which corresponds to the plane of FIG. 1A, e.g., the size of the image sensor 105 in the shorter side direction thereof. Then, in the embodiment of the invention, an arrangement relation between the exit surface 102b of the imaging side prism 102 and the image sensor 105 as defined by the conditional formula (1) is established. This arrangement enables to miniaturize the apparatus housing BD in the thickness direction thereof
0.0≦d/a<0.8 (1)

In the above formula (1), if d/a is 0.8 or larger the distance d between the exit surface 102b of the imaging side prism 102 and the light receiving surface of the image sensor 105 becomes too large, which obstructs reducing the thickness of the apparatus housing BD. In other words, a large distance d means a large imaging side prism for forming an optical image on the light receiving surface of the image sensor 105. As a result, the thickness of the imaging optical system 100 is increased as a whole.

On the other hand, the arrangement of d/a=0, namely, the arrangement of contacting the exit surface 102b of the imaging side prism 102 with the light receiving surface of the image sensor 105 may be a preferred arrangement in minimizing the size of the imaging optical system 100 in the direction of the arrows A. However, contact of the exit surface 102b with the light receiving surface of the image sensor 105 may give rise to difficulty in assembling. In addition to this drawback, there is likelihood that a ghost image may appear by plane reflection between the exit surface 102b and the light receiving surface of the image sensor 105. In order to avoid these drawbacks, it is desirable to set the lower limit of d/a at 0.1 or larger.

The imaging optical system 100 shown in FIG. 1A is an example of an optical system in which two reflecting prisms are used to bend an incident ray at about 90 degrees twice, so that the incident surface 101a of the incident side prism 101 is aligned substantially parallel to the exit surface 102b of the imaging side prism 102. In the embodiment of optimizing the arrangement relation between the exit surface 102b of the imaging side prism 102 and the light receiving surface of the image sensor 105, it is possible to use three or more reflecting prisms to form an optical path for guiding light in two dimensional or three dimensional manner in the apparatus housing BD. In such an arrangement, the incident surface 101a and the exit surface 102b may be or may not be aligned substantially parallel to each other.

Further alternatively, as shown in an imaging optical system 100′ shown in FIG. 1B, it is possible to arrange merely an imaging side prism 102 on the side of a light receiving surface of an image sensor 105. In the imaging optical system 100′, the optical axis AX from the subject H to the image sensor 105 is bent at about 90 degrees on a reflecting surface 102c of the imaging side prism 102 through an incident lens element 107. In this way, various optical arrangements are applicable to the embodiment of the invention. In the following section, the embodiment is described primarily based on the imaging optical system 100 shown in FIG. 1A.

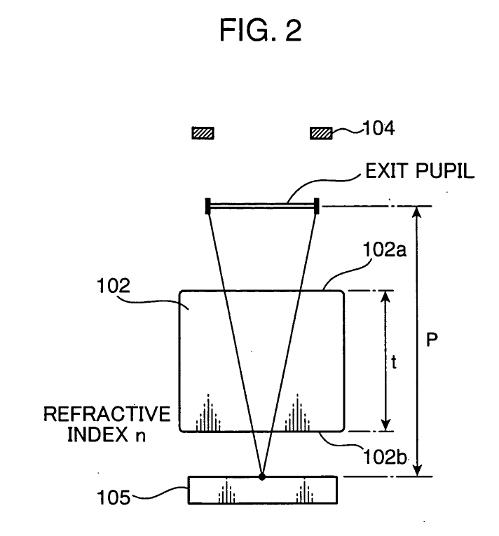

Next, a preferred optical arrangement of the imaging optical system 100 is described from various aspects. As mentioned above, the thickness of the imaging optical system 100 can be reduced not only by setting the arrangement relation between the exit surface 102b of the imaging side prism 102 and the image sensor 105 as defined above, but also by optimizing the size or the length of the imaging side prism 102. As shown in FIG. 2, it is desirable to satisfy the conditional formula (2) where n represents a refractive index of the imaging side prism 102, t represents a distance of a principal ray on the optical axis AX propagating through the imaging side prism 102, namely, a thickness of the imaging side prism 102 in an expanded state thereof, and p represents an exit pupil distance.
−1.5<(t·n)/p<1.0 (2)

In the formula (2), if (t·n)/p is 1.0 or more, since the exit pupil distance p becomes long relative to the size of the imaging side prism 102, the optical system is closer to a telecentric optical system. As a result, the width of light rays propagating in the imaging side prism 102 is increased, and the size or the length of the imaging side prism is unduly increased in order to allow the light rays of such a large width to repetitively propagate through the imaging side prism. Consequently, such an arrangement leads to failure of miniaturization of the imaging optical system 100.

On the other hand, if (t·n)/p is −1.5 or less, the exit pupil distance p becomes short relative to the size of the imaging side prism 102. As a result, the optical system is likely to pass a light ray of a large inclination with respect to the optical axis, contrary to a telecentric optical system. Generally, a micro lens element is arranged per pixel on the light receiving surface of the image sensor 105 to raise light focusing efficiency. In the case of a telecentric optical system, a micro lens element can be arranged substantially right above each pixel, which is a relatively easy operation. However, if the exit pupil distance p is short, and a light ray propagates with a large inclination with respect to the optical axis, it is necessary to arrange a micro lens element at a displaced position relative to each pixel, considering the inclination. If a light ray propagates with a large inclination due to a value of (t·n)/p smaller than the lower limit of the formula (2), it is difficult to arrange micro lens elements at intended positions to secure a required light amount for focusing. In such an arrangement, light focusing efficiency may be lowered, and the light amount around the micro lens elements may be reduced.

Further, a short exit pupil distance p means a short distance between the aperture stop 104 and the light receiving surface of the image sensor 105. In view of a fact that it is impossible to arrange the aperture stop 104 on the imaging side relative to an incident surface 102a of the imaging side prism 102, namely, it is impossible to provide an aperture stop inside a prism, it is difficult to dispose the aperture stop 104 at an appropriate position if the value of (t·n)/p is smaller than the lower limit of the formula (2).

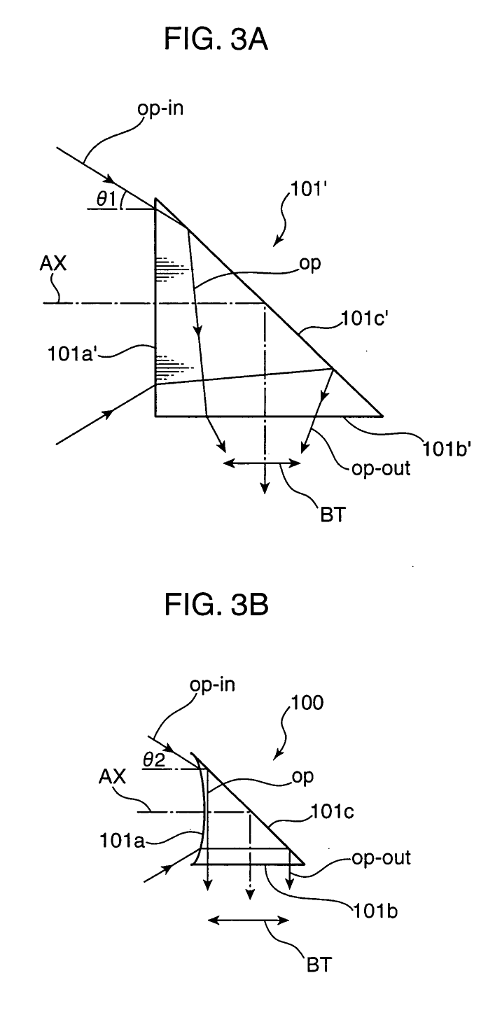

The following advantages are obtained in the arrangement as shown in FIG. 1A, in which the aperture stop 104 is disposed on the side of the exit surface 101b of the incident side prism 101, and the incident surface 101a of the incident side prism 101 has a negative optical power. FIGS. 3A and 3B are optical path diagrams each showing a relation between an incident side prism and a light ray. In the case where light rays having a certain width BT are allowed to go out of the incident side prism, it is preferable that an exit ray op-out propagating in an outermost peripheral region of the prism goes out from the prism substantially in parallel with the optical axis AX to miniaturize the prism itself.

Specifically, as shown in FIG. 3A, in the case where an incident surface 101a′ of an incident side prism 101′ is flat, it is impossible to minimize an incident angle θ1 of an incident ray op-in which is incident onto the incident surface 101a′ and propagates in an outermost peripheral region of the prism 101′ relative to the optical axis AX. As a result, the exit ray op-out goes out of the prism 101′ with a certain inclination relative to the optical axis AX. In such an arrangement, it is required to increase the areas of the incident surface 101a′ and an exit surface 101b′, considering the inclination, to secure a certain light width BT, which may cause size increase of the prism.

On the other hand, as shown in FIG. 3B, in the case where an incident surface 101a of an incident side prism 101 is concaved and has a negative optical power, an incident angle θ2 of an incident ray op-in which is incident onto the incident surface 101a and propagates in an outermost peripheral region of the incident side prism 101 is small relative to the optical axis AX. As a result, an exit ray op-out goes out of the prism 101 substantially parallel to the optical axis AX. This arrangement enables to remarkably reduce the size of the prism for securing a certain light width BT and contributes to miniaturization of the imaging optical system 100, as compared with the arrangement as shown in FIG. 3A.

Further, as shown in the imaging optical system 100 in FIG. 1A, it is preferable to arrange an optical device having a refractive power or an optical power on the optical path between the incident surface 101a of the incident side prism 101 and the exit surface 102b of the imaging side prism 102 without arranging an optical device having a refractive power or an optical power on the optical path on the side of the subject H relative to the incident surface 101a of the incident side prism 101 or on the optical path on the side of the image sensor 105 relative to the exit surface 102b of the imaging side prism 102. As compared with the arrangement that an optical device having a refractive power is arranged on the optical path on the side of the subject H relative to the incident surface 101a of the incident side prism 101, this arrangement enables to reduce the thickness of the imaging optical system 100 in the direction of the arrows A, which contributes to miniaturization of the imaging optical system 100.

Further, in the imaging optical system 100, it is preferable to arrange a lens element or a lens group between the incident side prism 101 and the imaging side prism 102 to correct field curvature, aberration or a like drawback and to improve optical performance of the imaging optical system 100. In arranging the lens element or the like, a drawback of unduly increasing the size of the optical system in the direction of the arrows A resulting from loading of the lens element can be avoided by adopting a lens element having a size smaller than the reflecting prism in the direction of the arrows A.

It is preferable to drive the lens element or the lens group in an optical axis direction thereof, namely, in a direction substantially parallel with the incident surface 101a of the incident side prism 101 for focusing for the following reason. If the entirety of an imaging optical system including a reflecting prism is driven in the optical axis direction, such an arrangement may give rise to drawbacks such as size increase of a drive motor due to increase of the weight of a device to be driven, non-alignment of the optical axis by the driving, and complexity of a mechanism for supporting the optical devices of the imaging optical system. Arranging a lens element or a lens group between the two reflecting prisms enables to securely hold the reflecting prisms and the aperture stop, and driving the lens element or the lens group in the optical axis direction enables to eliminate various drawbacks such as size increase of a drive motor, occurrence of non-alignment of the optical axis, and complexity of an optical device supporting mechanism.

In the imaging optical system 100 as shown in FIG. 1A, the focusing lens element 103 is arranged between the incident side prism 101 and the imaging side prism 102 to satisfy the above requirements. In other words, focusing is implemented by driving the focusing lens element 103 in a direction parallel to the incident surface 101a of the incident side prism 101.

In the imaging optical system 100, it is preferable to make the optical surfaces of the respective optical devices of the imaging optical system 100 symmetrical to each other with respect to the optical axis AX, namely, rotationally symmetrical to each other in light of feasibility of production of the optical devices such as the incident side prism 101, the imaging side prism 102, and the lens element 103. An axially asymmetrical optical system is not desirable because production of such an optical system is difficult, and production cost may rise, considering evaluation in assembling and difficulty in adjustment. However, it is possible to use axially asymmetrical surfaces as reflecting surfaces, as far as cost increase is permissible.

There is a case that if a CCD image sensor or a CMOS image sensor is used as the image sensor 105, an infrared component may cause a noise, which may degrade an output image. In view of this, a measure of arranging an infrared cut filter or a like element at an appropriate position of an imaging optical system has been conducted to keep an infrared component from being incident onto the image sensor 105. However, such a measure requires an optical component having an infrared blocking function as an additional part, which may hinder miniaturization of the imaging optical system, and reduction of the number of parts.

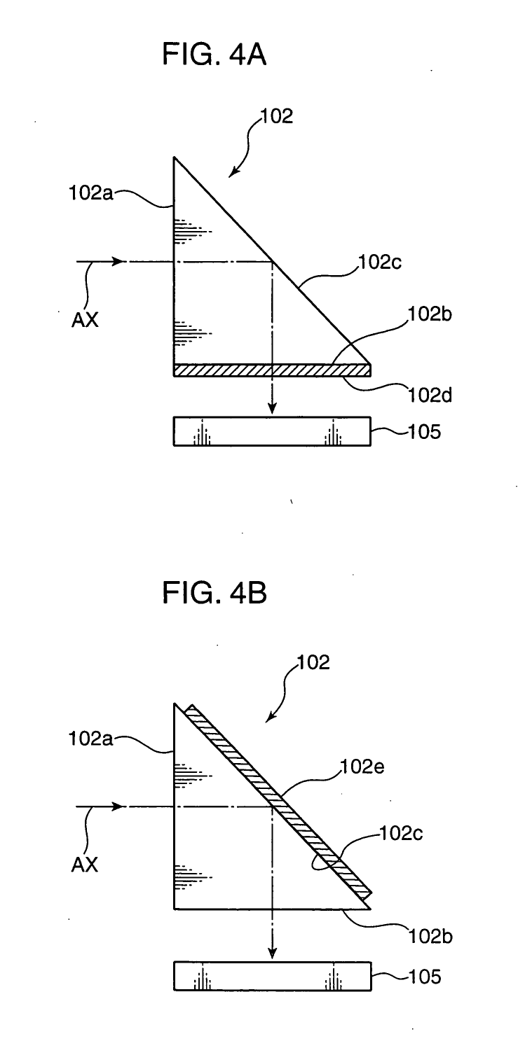

In view of the above, it is desirable to provide the imaging side prism 102 itself with an infrared blocking function of reducing or removing an infrared component included in an incident ray. FIGS. 4A and 4B are cross-sectional views each showing an example of an imaging side prism 102 equipped with an infrared blocking function. FIG. 4A shows an example that an infrared reflecting film 102d is integrally formed on an exit surface 102b of an imaging side prism 102. In this arrangement, an infrared component included in an incident ray is reflected by the infrared reflecting film 102d to thereby keep the infrared component from being incident onto an image sensor 105. A preferred example of the infrared reflecting film 102d is an inductive multilayer coating which reflects light in the range of an infrared wavelength. It is possible to attach the infrared reflecting film 102d on the incident surface 102a of the imaging side prism 102.

FIG. 4B shows an example that an infrared absorbing film 102e is integrally formed on a reflecting surface 102c of an imaging side prism 102. In this arrangement, an infrared component included in an incident ray is absorbed by the infrared absorbing film 102e to thereby keep the infrared component from being incident onto an image sensor 105. A preferred example of the infrared absorbing film 102e is an inductive multilayer coating which absorbs light in the range of an infrared wavelength. It is possible to attach an infrared transparent film on the reflecting surface 102c to pass merely an infrared component through the imaging side prism 102.

Next, materials and production methods of the incident side prism 101 and the imaging side prism 102 are described. There is no specific limit to the material for the prisms 101 and 102. An optical material having a certain light transparency or a certain refractive index such as various kinds of glass materials, and resins (plastic) materials is usable. Use of a resin material is advantageous, as compared with a case of using a glass material, in the aspect of production cost and production of a lightweight imaging optical system, because use of the resin material enables to realize mass-production of lightweight prisms by injection molding or a like technique. Further, in the case of producing a reflecting prism with an incident surface and/or an exit surface having a refractive power, as mentioned above, a grinding process is necessary, if the reflecting prism is made of a glass material. Compared with use of a glass material, use of a resin material is advantageous because a reflecting prism can be easily produced with use of a mold form or a like device.

Production of optical components having high precision may be difficult according to injection molding, because heat shrinkage of some extent is unavoidable after the molding. The imaging side prism 102 requires less precision as compared with the incident side prism 101, because the imaging side prism 102 is disposed closer to the image sensor 105, and error sensitivity thereof is relatively small. In view of this, it is desirable to make at least the imaging side prism 102 of a resin material, and to make the incident side prism 101 of a resin material or a glass material depending on a required precision.

In the case of making the incident side prism 101 and/or the imaging side prism 102 of a resin material, it is possible to use various optical resin materials such as polycarbonate and polymethyl methacrylate (PMMA) as the resin material. Among these, it is desirable to use a resin material having a water absorption coefficient of 0.01% or smaller. A resin material has a moisture absorption power of bonding with water components in the air. If such a moisture absorption power is acted, optical characteristics such as a refractive index may be changed even if the prism is fabricated as designed. In view of this, the imaging optical system 100 free of moisture absorption power can be produced by using a resin material having a water absorption coefficient of 0.01% or less. An example of the resin material having a water absorption coefficient of 0.01% or less is available under the trade name of ZEONEX® produced by Zeon Corporation.

Examples of the method for producing a prism with an incident surface and/or an exit surface having an optical power include cementing a lens element having an optical power with a predetermined prism, grinding a prism to make a curved surface, an injection molding technique, and a glass molding technique. In the technique of cementing a lens element with a prism or in the technique of grinding a prism into a curved surface, axial alignment is required to adjust a positional relation of the reflecting surface of the prism to the lens element to be cemented or to the curved surface of the prism, or an inclination of the prism and the lens element relative to the optical axis, which may make the production process complicated. As compared with the above, an injection molding technique with use of a resin material is preferred because of its superior mass-productivity.

It is desirable to consider the following points in adopting a prism produced by the injection molding. In conducting the injection molding, a gate is necessary for injecting a resin material into a mold. The gate may oppose to any surface of a prism to be molded. However, preferably, the gate may be arranged at a surface of the prism other than a surface used for light incidence, emergence, and reflection. This arrangement is preferred because generally, birefringence is likely to occur on or around the site of the prism where the gate is arranged because trace of resin flow is likely to be formed on the gate arranged site of the prism, which may give adverse effects to optical characteristics of the resultant prism. Arranging the gate at a surface of the prism other than the surface used for light incidence, emergence, and reflection enables to reduce an influence of birefringence, even if birefringence occurs.

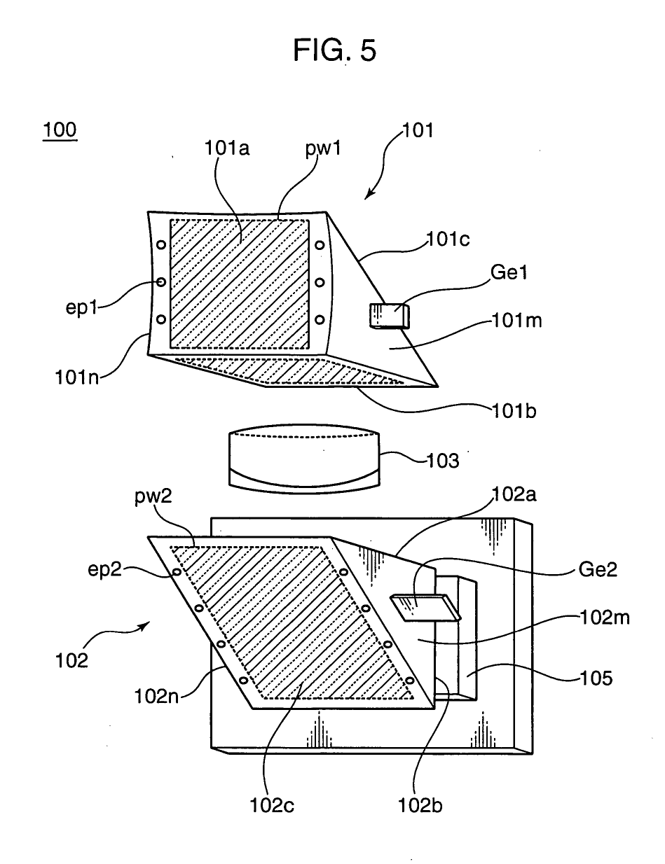

FIG. 5 is a perspective view of the imaging optical system 100 shown in FIG. 1A depicted in a stereoscopic manner. A preferred arrangement of the imaging optical system 100 provided with a prism produced by the injection molding is described referring to FIG. 5. Referring to FIG. 5, in forming the incident side prism 101 by the injection molding, a gate for injecting a resin material into a mold is arranged at an unused surface 101m, which is a surface of the prism other than the incident surface 101a, the exit surface 101b, and the reflecting surface 101c. Generally, since a gate has a prismatic configuration of a rectangular shape in cross section, a gate trace Ge1 of a prismatic configuration having a surface of a broad width parallel with the incident surface 101a is formed on the unused surface 101m. It should be noted that the gate trace Ge1 is illustrated with a larger magnification than the other parts. Arranging the gate in the above-mentioned manner enables to reduce an influence of birefringence which may affect an effective usable area pw1 of the incident side prism 101 shown by the hatched portions in FIG. 5 where light rays are allowed to propagate, even if birefringence occurs in the vicinity of the gate trace Ge1.

Similarly to the incident side prism 101, the imaging side prism 102 is produced by arranging a gate for injecting a resin material into a mold at an unused surface 102m, which is a surface of the prism other than the incident surface 102a, the exit surface 102b, and the reflecting surface 102c. In this case, a gate trace Ge2 of a prismatic configuration having a surface of a broad width parallel with the reflecting surface 102c is formed on the unused surface 102m. Arranging the gate in the above-mentioned manner enables to reduce an influence of birefringence which may affect an effective usable area pw2 of the imaging side prism 102 shown by the hatched portion in FIG. 5, even if birefringence occurs in the vicinity of the gate trace Ge2.

It is a common practice to pressingly take out a molded product, in this case, a prism from the mold with use of eject pins after the injection molding. In this case, traces of the eject pins are also likely to be formed in a site of the prism where the eject pins have been contacted, and optical characteristics may be varied on or around the trace forming site. In the example shown in FIG. 5, eject pins are arranged at a site corresponding to an unused area of the incident surface 101a of the incident side prism 101, so that traces ep1 of the eject pins appear on the unused area. Likewise, eject pins are arranged at a site corresponding to an unused area of the reflecting surface 102c of the imaging side prism 102, so that traces ep2 of the eject pins appear on the unused area. Alternatively, it is possible to arrange eject pins in such a manner that traces ep1 of the eject pins for the incident side prism 101 appear on an unused surface 101n opposite to the unused surface 101m, and traces ep2 of the eject pins for the imaging side prism 102 appear on an unused surface 102n opposite to the unused surface 102m.

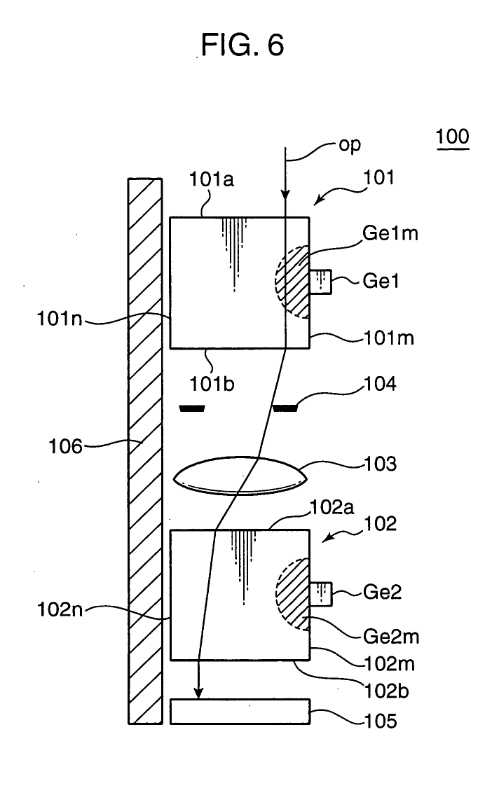

In the case where the aperture stop 104 is arranged between the incident side prism 101 and the imaging side prism 102 as shown in the imaging optical system 100 of FIG. 1A, it is desirable to arrange the gates at such a position that the gate trace Ge1 on the incident side prism 101 and the gate trace Ge2 on the imaging side prism 102 extend in the same direction, as shown in FIG. 5, in assembling the prisms 101, 102 in the apparatus housing BD. This is described referring to FIG. 6.

FIG. 6 is a schematic optical path diagram of the imaging optical system 100 shown in FIG. 5. As illustrated in FIG. 6, the gate trace Ge1 on the incident side prism 101 and the gate trace Ge2 on the imaging side prism 102 are respectively formed on the unused surfaces 101m and 102m aligned in the same direction. The unused surfaces 101n, 102n opposite to the unused surfaces 101m, 102m are flat without formation of the gate traces Ge1, Ge2, namely, stable surfaces in configuration. Therefore, the unused surfaces 101n, 102n are fixedly supported on a prism supporting member 106 commonly provided for the incident side prism 101 and the imaging side prism 102. The prism supporting member 106 corresponds to a frame member of the apparatus housing BD or a like element. With this arrangement, the prisms 101, 102 can be assembled in the apparatus housing BD with high precision.

An influence of birefringence or a like phenomenon can be reduced to some extent, but cannot be completely removed by forming the gate traces Ge1, Ge2 on the unused surfaces 101m, 102m, respectively. Ge1m, Ge2m shown by the hatched portions in FIG. 6 are gate affecting areas, which may affect optical characteristics of the incident side prism 101 and the imaging side prism 102 in the vicinity of the gate traces Ge1, Ge2, respectively.

In the case where the aperture stop 104 is arranged between the incident side prism 101 and the imaging side prism 102, optical images turn upside down before and after passing the aperture stop 104. Considering the optical path of an incident ray op which is incident onto the incident surface 101a of the incident side prism 101 from the side where the gate trace Ge1 is formed, since the incident ray op passes through the gate affecting area Ge1m in the incident side prism 101, the incident ray op may be affected by birefringence or the like. The incident ray op, after passing the aperture stop 104, is bent in a direction away from the gate trace Ge1. When the incident ray op is incident onto the imaging side prism 102, the incident ray op propagates in the imaging side prism 102 in a region away from the gate affecting area Ge2m. This arrangement keeps the incident ray op from passing both through the gate affecting area Ge1m of the incident side prism 101 and the gate affecting area Ge2m of the imaging side prism 102. With this arrangement, an influence of residue birefringence can be alleviated, which eliminates likelihood that substantially a half region of a displayed image may be affected by an influence of birefringence or the like.

The injection molding using the resin material is suitable for mass production and is advantageous in forming a concave incident or exit surface of high precision in a reflecting prism. However, according to the injection molding, it is impossible to fabricate a reflecting prism having a high refractive index in light of a fact that a resin material is used. In view of this, it is desirable to fabricate a prism having a high refractive index and high precision according to glass molding by heating a glass material having a high refractive index in a mold having a shape of a prism under pressurization. Use of a prism having a high refractive index enables to shorten the optical path length and suppress generation of aberration on a refracting surface, which makes it possible to realize miniaturization of the imaging optical system 100, and reduction of the number of lens elements, and is advantageous in producing a compact digital apparatus.

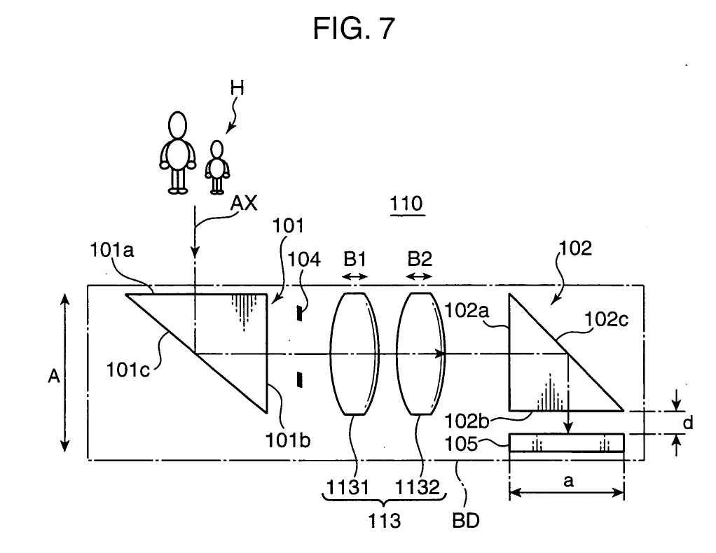

FIG. 7 is an illustration schematically showing another embodiment of the invention, specifically, a zoom optical system 110 capable of performing zooming operation, as an example of the imaging optical system. Similarly to the imaging optical system 100 as shown in FIG. 1A, the zoom optical system 110 is designed to form an optical image of a subject H on a light receiving surface of an image sensor 105 which converts the optical image into electrical signals. The zoom optical system 110 has two reflecting prisms, namely, an incident side prism 101 disposed on the side of the subject H on the optical path, and an imaging side prism 102 disposed on the side of the image sensor 105 on the optical path. The zoom optical system 110 is different from the imaging optical system 100 in that a lens group 113 for zooming and focusing is provided between the incident side prism 101 and the imaging side prism 102 in addition to an aperture stop 104.

The lens group 113 includes variable lens elements 1131 and 1132 which are movable in the directions of the arrows B1 and B2 in FIG. 7, respectively. Specifically, the variable lens elements 1131 and 1132 are driven for zooming in the optical axis direction of the lens group 113, namely, in a direction substantially parallel to an incident surface 101a of the incident side prism 101. This is to avoid the following drawbacks. If the entirety of a zoom optical system including a reflecting prism is driven in the optical axis direction, such an arrangement may give rise to drawbacks such as unduly increase of the thickness of the optical system due to change of the thickness of the entirety of the optical system, or size increase of a drive motor due to increase of the weight of a device to be driven. In addition to the above, there are drawbacks such as non-alignment of the optical axis due to the driving, and complexity of a mechanism for supporting the optical devices of the zoom optical system. Arranging a lens group between the two reflecting prisms and driving the lens group in the optical axis direction enables to fixedly support the reflecting prisms and the aperture stop, and to eliminate various drawbacks such as size increase of a drive motor, occurrence of non-alignment of the optical axis, and complexity of an optical device supporting mechanism.

Generally, in zooming, two lens groups, namely, a variator lens group and a compensator lens group are required to be moved. In view of this, preferably, at least two lens groups are arranged between the two prisms, with each of the lens groups being movable in the optical axis direction for an intended zooming operation. Moving the two lens groups individually along the optical axis direction enables to produce a thin and compact zoom optical system loadable into a mobile phone or a PDA, because this arrangement is free from a change of the thickness of the optical system in zooming. Further, moving both of the two lens groups enables to shorten the moving distance of the respective lens groups, as compared with an arrangement of moving a single lens group, which leads to miniaturization of the optical system. Alternatively, it is possible to move a single lens group in zooming by properly regulating a zoom resolution as in the case of an optical zoom system.

In the zoom optical system 100 as shown in FIG. 7, the variable lens elements 1131 and 1132 are arranged between the incident side prism 101 and the imaging side prism 102 to meet the above requirements. In other words, zooming is performed by moving the variable lens elements 1131 and 1132 in directions parallel to the incident surface 101a of the incident side prism 101, namely, in the directions of the arrows B1 and B2, respectively.

As in the case of the imaging optical system 100 as shown in FIG. 1A, in the zoom optical system 110, at least one of the incident surface 101a of the incident side prism 101 and the incident surface 102a of the imaging side prism 102, or at least one of the exit surface 101b of the incident side prism 101 and the exit surface 102b of the imaging side prism 102 has an optical power. Further, there is established an arrangement relation between the exit surface 102b of the imaging side prism 102 and the light receiving surface of the image sensor 105, as defined by the conditional formulae (1) and (2). In addition to this, the same idea as applied to the imaging optical system 100 is applied to the zoom optical system 110 regarding formation of a gate trace on a reflecting prism, and a preferred optical arrangement such as an arrangement as to how an optical power is given to a reflecting prism.

### Description on Digital Apparatus Incorporated with Imaging Optical System

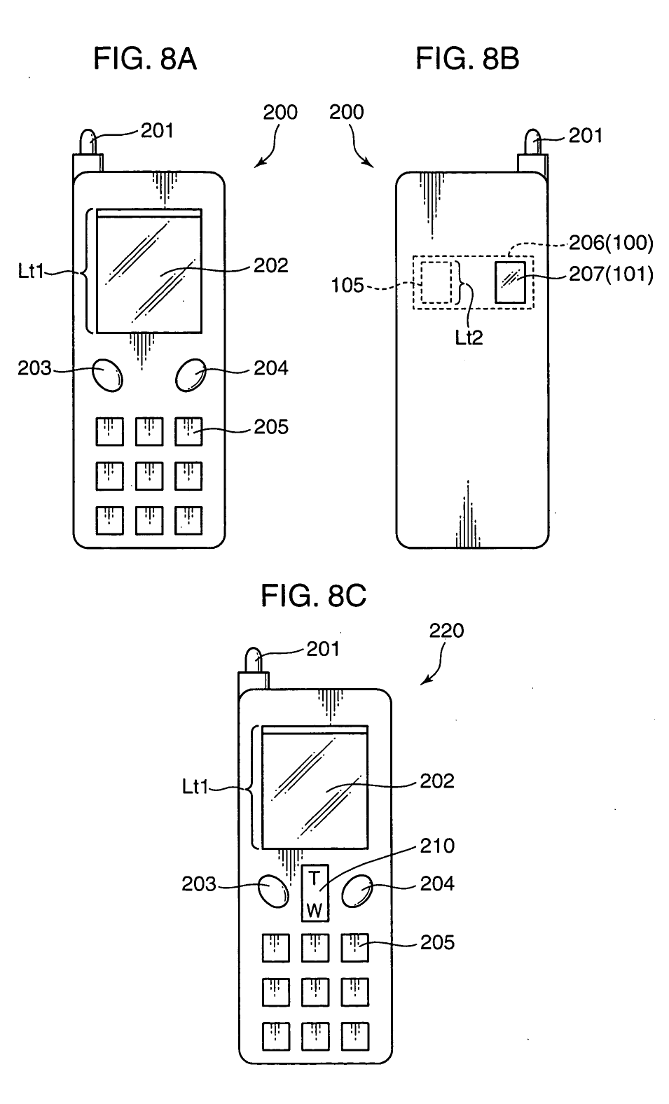

Next, a digital apparatus incorporated with the imaging optical system 100 or the zoom optical system 110 is described. FIGS. 8A and 8B are external schematic views of a camera phone 200 loaded with the imaging optical system 100, and FIG. 8C is an external schematic view of a camera phone 220 loaded with the zoom optical system 110. The camera phones 200 and 220 are examples of the inventive digital apparatus. In the embodiment of the invention, examples of the digital apparatus include a digital still camera, a digital video camera, a digital video unit, a personal digital assistant (PDA), a personal computer, a mobile computer, and peripheral devices thereof such as a mouse, a scanner, and a printer. The digital still camera or the digital video camera corresponds to an imaging lens device which converts, after optically reading a video image of a subject, the video image into electrical signals using a semiconductor device, and stores the electrical signals into a storage medium such as a flash memory. Further, in the embodiment of the invention, the digital apparatus includes a mobile phone, a PDA, a personal computer, a mobile computer, and peripheral devices thereof each having specifications of incorporating a compact imaging lens device for optically reading a still image or a video image of a subject.

FIG. 8A shows an operating face of the camera phone 200, and FIG. 8B shows a back face of the camera phone 200. The camera phone 200 includes at an upper part thereof an antenna 201, and on the operating face thereof a rectangular display 202 having a longer side Lt1 extending in a vertical direction on the plane of FIG. 8A, a mode switchover button 203 for activating the image shooting mode and for switching over the image shooting mode between still image shooting and moving image shooting, a shutter button 204, and a dial button 205.

In the case where a zoom optical system is incorporated in the camera phone 220 as shown in FIG. 8C, a zoom button 210 for controlling zooming is provided on the operating face of the camera phone 220. The symbol “T” indicating the telephoto limit of the optical system is marked on an upper end portion of the zoom button 210, and the symbol “W” indicating the wide angle limit of the optical system is marked on a lower end portion of the zoom button 210. The zoom button 210 is constituted of a two-contact switch constructed such that telephoto shooting or wide-angle shooting is allowed in response to pressing of the upper end portion or the lower end portion of the zoom button 210.

An imaging lens device (camera) 206 including an imaging optical system 100, and an image sensor 105 such as a CCD sensor are incorporated in the camera phone 200. A taking lens element 207 of the imaging lens device 206 is exposed out of the back face of the camera phone 200 for receiving light representing an optical image of a subject. An incident surface 101a of an incident side prism 101 is arranged on the back face of the taking lens element 207. In other words, the incident surface of the taking lens device 206 for passing incident light of a subject and the display 202 are arranged on the back face and the operating face of the camera phone 200, respectively. With this arrangement, an image acquired through the taking lens device 206 can be captured while the image is displayed on the display 202.

The image sensor 105 is of a rectangular shape with an aspect ratio of an imaging area at 4:3, for instance. An image sensor of a multi-purpose use is generally of a rectangular shape. It is desirable to incorporate the imaging lens device 206 including the image sensor 105 in the camera phone 200 as shown in FIGS. 8A and 8B, considering the arrangement relation with the rectangular display 202.

Specifically, in the case where the display 202 has the longer side Lt1 extending in the vertical direction on the plane of FIG. 8A, preferably, the image sensor 105 has a longer side Lt2 extending in a vertical direction on the plane of FIG. 8B. In other words, it is desirable to assemble the display 202 and the image sensor 105 in such a manner that the longer side Lt1 of the display 202 and the longer side Lt2 of the image sensor 105 are aligned parallel to each other in the same direction. Thereby, an optical image of a subject that has been incident through the taking lens device 207 and captured on the rectangular imaging area of the image sensor 105 is effectively displayed on the rectangular display 202.

More specifically, if the longer side Lt1 of the display 202 and the longer side Lt2 of the image sensor 105 are aligned parallel to each other, the longer side direction of the image captured by the image sensor 105 and the longer side direction of the display image are coincident with each other. With this arrangement, an image can be effectively displayed on the display area of the display 202 to thereby enable to display the image enlargedly. In other words, this arrangement enables image display of maximally utilizing the display area of the display 202, which is advantageous in confirming the image composition in image shooting or the like. The same idea is applied to the case that the zoom optical system is incorporated in the camera phone 220 as shown in FIG. 8C.

The taking lens device 206 may include a plane parallel plate corresponding to an optical low-pass filter or the like, in addition to the imaging optical system 100 for forming an optical image of a subject. Examples of the optical low-pass filter include, for instance, a birefringent low-pass filter made of a crystal or a like material whose crystallographic axis direction has been regulated, and a phase-type low-pass filter capable of realizing required optical cutoff frequency characteristics by diffraction effect.

An optical low-pass filter may not be an essential element. Further alternatively, an infrared cut filter may be provided in place of an optical low-pass filter to reduce a noise included in an image signal outputted from the image sensor 105. In this case, it is desirable that the reflecting prism has an infrared blocking function as mentioned above. Further alternatively, it is possible to allow a single element to exhibit functions of an infrared cut filter and an optical low-pass filter by applying infrared reflecting coat on a surface of an optical low-pass filter.

An image shooting operation of the camera phone 200 having the above construction is described below. In shooting a still image, the image shooting mode is activated by pressing the mode switchover button 203 one time. In this embodiment, depressing the mode switching button 203 one more time switches over the image shooting mode from the still image shooting mode to the moving image shooting mode. When the still image shooting mode is activated, a subject image is cyclically captured by the image sensor 105 such as a CCD sensor through the imaging lens device 206. Then, after the acquired image data is transferred to a memory for display, the image is displayed on the display 202. The photographer can move the subject image to an intended position within the display screen while viewing the image through the display 202. When the photographer depresses the shutter button 204 with the subject image being located at the intended position, a still image of the subject is obtained. Thus, image data representing the captured still image is stored in a memory for storing the still image data.

In the case of conducting moving image shooting, after the still image shooting mode is activated by depressing the mode switching button 203 one time, the mode switching button 203 is depressed once again to change the image shooting mode to the moving image shooting. Thereafter, similarly to the still image shooting, the photographer views the subject image through the display 202 to move the subject image captured through the imaging lens device 206 to an intended position within the display screen. When the photographer depresses the shutter button 204 in this state, the photographer can start moving image shooting. When the photographer depresses the shutter button 204 again in this state, the moving image shooting is terminated. The captured moving image data is sent to a memory for displaying the moving image on the display 202, and is also sent to a memory for storing the moving image data for storage.

On the other hand, in the case of the camera phone 220 incorporated with the zoom optical system as shown in FIG. 8C, zoom shooting is operable. Specifically, when zoom shooting performed under the condition that a subject is located away from the photographer, or the photographer wishes to capture the subject enlargedly, the photographer depresses the upper end portion of the zoom button 210 where the symbol “T” is marked. Then, the state that the zoom button 210 is being depressed toward the telephoto limit is detected, and a lens driving for zooming is executed for a time duration while the zoom button 210 is depressed to carry out continuous zooming. If the photographer wishes to reduce the magnification of the subject image to life-size magnification, for example, in an excessive zooming, the photographer depresses the lower end portion of the zoom button 210 where the symbol “W” is marked. Then, the state that the zoom button 210 is being depressed toward the wide-angle limit is detected, and a continuous zooming toward the life-size magnification is carried out for a time duration while the zoom button 210 is depressed. In this way, the photographer can vary the zoom ratio with use of the zoom button 210, even if the subject is located away from the photographer. Similarly to ordinary life-size shooting, the photographer can capture an enlarged still image by moving the subject image within the display screen to an intended position, and by depressing the shutter button 204 with the subject image being located at the intended position.

Further, during the moving image shooting, the photographer can vary the zoom ratio of the subject image desirably by manipulating the zoom button 210. Specifically, the moving image shooting is started in response to depressing of the shutter button 204 by the photographer. During the moving image shooting, the zoom ratio of the subject image can be arbitrarily changed by manipulating the zoom button 210. When the photographer depresses the shutter button 402 again in this state, the moving image shooting is terminated.

The construction of the zoom button 210 in the camera phone 220 is not limited to the foregoing. The dial button 205 may be used as a zoom button. Alternatively, it is possible to use a member having two-directional zooming function, namely, enlargement and reduction, such as a rotary dial member which is rotatably supported about an axis of rotation on the operating face where the dial button is installed.

In the foregoing embodiment, the longer side Lt1 of the display 202 and the longer side Lt2 of the image sensor 105 are aligned parallel to each other in the vertical directions on the plane of FIGS. 8A through 8C. Alternatively, it is possible to align the longer side Lt1 of the display 202 and the longer side Lt2 of the image sensor 105 parallel to each other in a certain direction, e.g., transverse directions, on the plane of FIGS. 8A through 8C. Such an altered arrangement enables image display of maximally utilizing the display area of the display 202, which contributes to effective confirmation of the image composition in image shooting.

The same idea as applied to the camera phones 200 and 220 is applied to various digital apparatuses incorporated with a display as a display device, such as a foldable camera phone, a digital still camera, a digital video camera, a PDA, a personal computer, a mobile computer, and peripheral devices thereof.

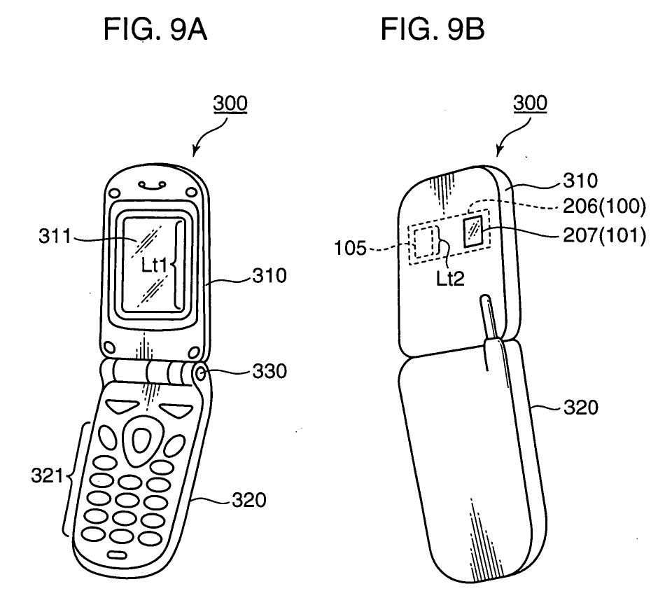

FIGS. 9A and 9B are external schematic views each showing a foldable camera phone 300. FIG. 9A shows an operating face of the camera phone 300, and FIG. 9B shows a back face of the camera phone 300. The camera phone 300 is of a foldable type, wherein a first casing 310 and a second casing 320 are coupled to each other by a hinge member 330. A vertically elongated display 311 is provided on the operating face of the first casing 310, and a key entering section 321 serving as an operating section is provided on the operating face of the second casing 320.

The camera phone 300 is constructed in such a manner that a taking lens device 206 including an imaging optical system 100 or a zoom optical system 110, and an image sensor 105 are arranged in the first casing 310, and a taking lens element 207 of the taking lens device 206 is exposed out of the back face of the first casing 310. Specifically, an incident surface of the taking lens device 206 for receiving an optical image of a subject and a display 311 are arranged on the back face and the operating face of the first casing 310, respectively. With this arrangement, an image can be captured while the image acquired through the taking lens device 206 is displayed on the display 311. The display 311 and the image sensor 105 are assembled in such a manner that a longer side Lt1 of the display 311 and a longer side Lt2 of the image sensor 105 are aligned parallel to each other in the same direction. Thereby, an optical image of a subject that has been incident through the taking lens element 207 and captured on a rectangular imaging area of the image sensor 105 can be effectively displayed on the rectangular display 311 in image shooting.

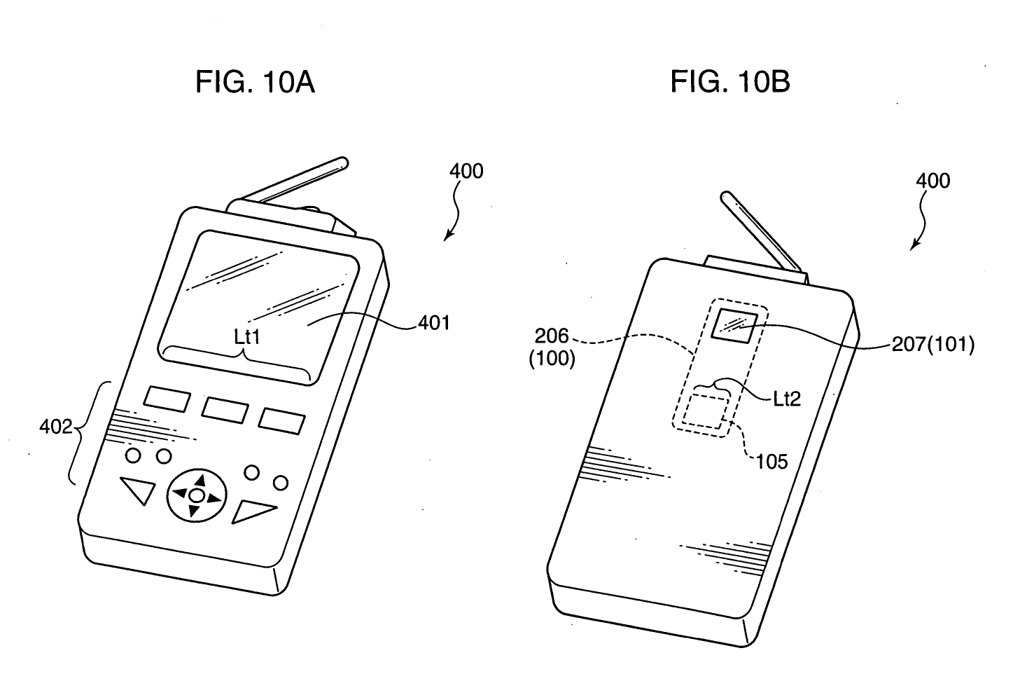

FIGS. 10A and 10B are external schematic views of a PDA, wherein FIG. 10A shows an operating face of the PDA 400, and FIG. 10B shows a back face thereof. A transversely elongated display 401, and a key entering section 402 serving as an operating section are provided on the operating face of the PDA 400.

The PDA 400 is constructed in such a manner that a taking lens device 206 including an imaging optical system 100 or a zoom optical system 110, and an image sensor 105 are incorporated in a housing of the PDA 400, with a taking lens element 207 of the taking lens device 206 being exposed out of the back face of the PDA 400. Specifically, an incident surface of the taking lens device 206 for receiving an optical image of a subject and the display 401 are arranged on the back face and the operating face of the PDA 400, respectively. With this arrangement, an image can be captured while the image acquired through the taking lens device 206 is displayed on the display 401. The display 401 and the image sensor 105 are assembled in such a manner that a longer side Lt1 of the display 401 and a longer side Lt2 of the image sensor 105 are aligned parallel to each other in a certain direction, in this case, a horizontal direction. Thereby, an optical image of a subject that has been incident through the taking lens element 207 and captured on a rectangular imaging area of the image sensor 105 can be effectively displayed on the rectangular display 401 in image shooting.

Hereinafter, the terms “concave”, “convex”, and “meniscus” are used regarding lens elements. It should be noted that these terms represent the respective configurations of a lens element in the vicinity of the optical axis, namely, near the central part of the lens element, and do not indicate the respective configurations of the entirety of the lens element or a periphery of the lens element. As far as the lens element is spherical, the configuration of the lens element does not matter. However, since the configuration of an aspherical lens element is generally different in the vicinity of the central part thereof and in a periphery thereof, the above definitions on the terms are necessary. The aspherical lens element includes lens elements having surfaces of different configurations such as a paraboloidal surface, an ellipsoidal surface, a hyperboloidal surface, and a quartic surface.

Further, throughout the specification and the claims, the optical power of a single lens element and the optical power of each single lens element constituting a cemented lens element indicate a power of the single lens element itself assuming that both of the lens surfaces of the single lens element have a boundary with the air.

### Description on Embodiments of Imaging Optical System

In the following, embodiments of the imaging optical system 100 as shown in FIG. 1A, specifically, exemplified arrangements of the imaging optical system 100 constituting the imaging lens device 206 to be loaded in the camera phone 200 as shown in FIGS. 8A and 8B, the camera phone 220 as shown in FIG. 8C, the camera phone 300 as shown in FIGS. 9A and 9B, or the portable digital assistant (PDA) 400 as shown in FIGS. 10A and 10B are described referring to the drawings.

### First Embodiment

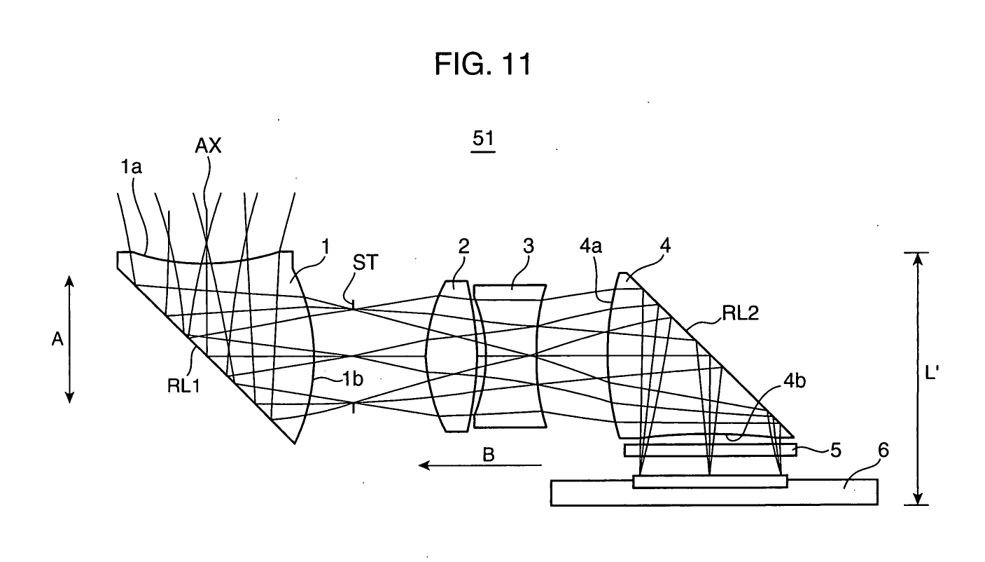

FIG. 11 is a cross-sectional view of an arrangement of an imaging optical system 51 as a first embodiment taken along a longitudinal direction of the optical axis (AX) in FIG. 11. As shown in FIG. 11, the imaging optical system 51 has, from the object side along the optical path, a first reflecting prism 1 having a positive optical power as a whole, which corresponds to the incident side prism 101 shown in FIG. 1A, an aperture stop (ST) for regulating the light amount, a first lens element 2 having a positive optical power, a second lens element 3 having a negative optical power, and a second reflecting prism 4 having a positive optical power as a whole, which corresponds to the imaging side prism 102 shown in FIG. 1A. A plane parallel plate 5 and an image sensor 6 are arranged on the side of the second reflecting prism 4 opposite to the second lens element 3.

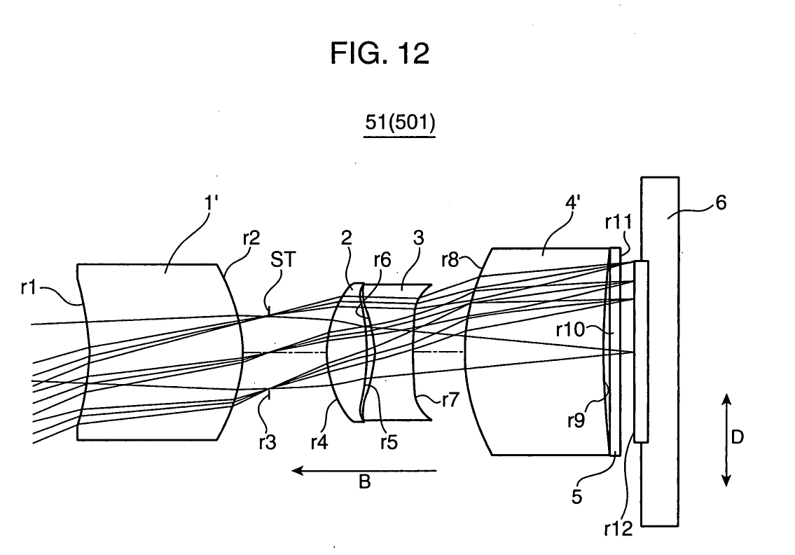

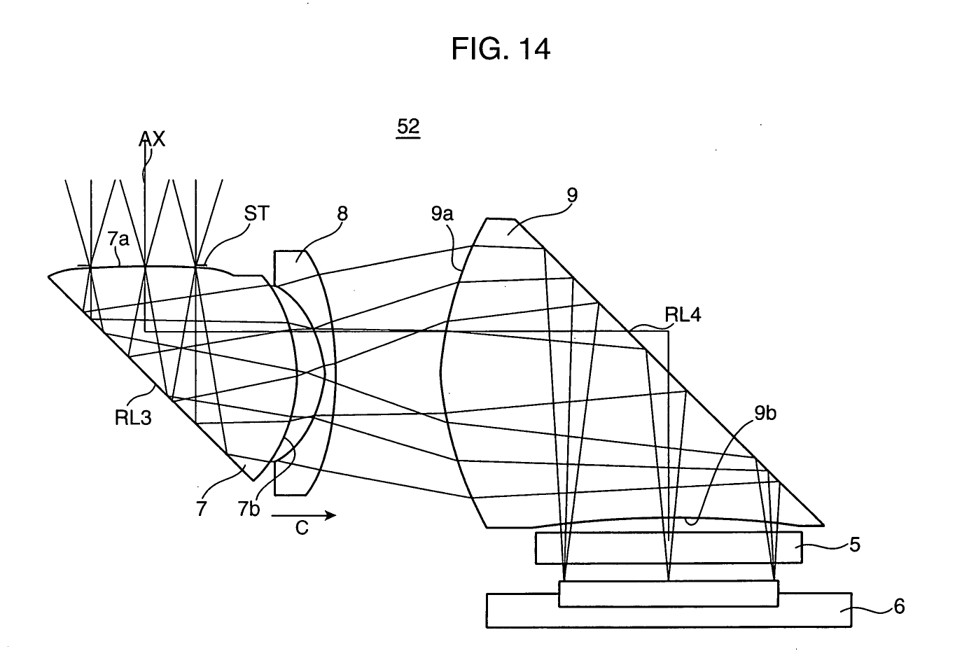

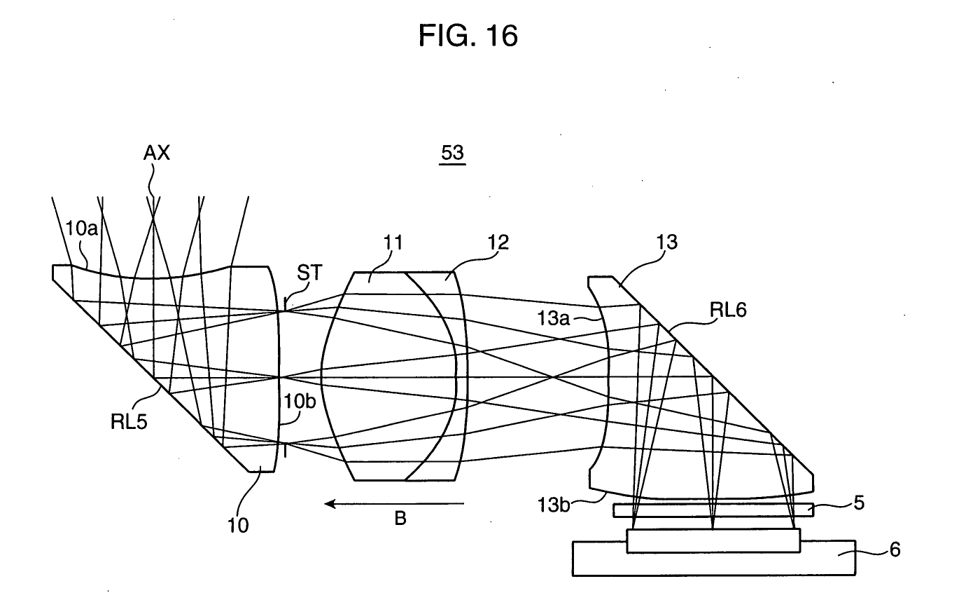

FIG. 11, as well as FIGS. 14 and 16 respectively showing a second embodiment and a third embodiment of the invention, which will be described later, each shows an arrangement of optical devices with an infinite focal length. FIGS. 12, 15, and 17 are illustrations each showing an arrangement of an imaging optical system, wherein a lens element having a function substantially equivalent to the function of a reflecting prism such as a first reflecting prism and a second reflecting prism shown in FIGS. 11, 14, and 16 is used in place of the reflecting prism shown in FIGS. 11, 14, and 16, respectively. The direction of the arrows D in FIG. 12 (15 or 17) corresponds to the longer side direction of the image sensor 6. The imaging optical systems shown in FIGS. 11, 14, and 16 each is an imaging optical system, wherein an incident ray is bent in the shorter side direction of the image sensor 6. The optical power throughout the specification and the claims means a power in a condition that mediums on both surfaces of the lens element are the air. The image sensor 6 has an aspect ratio of 3:4, for instance, has a size of 1.8 mm in vertical direction and 2.4 mm in horizontal direction. The directions shown by the arrows A in FIG. 11 correspond to the thickness direction of the camera phone shown in FIGS. 8A through 8C.

Referring to FIG. 11, the first reflecting prism 1 has an incident surface la of a negative optical power, an exit surface 1b of a positive optical power, and a planar reflecting surface RL1 arranged on the optical path between the incident surface 1a and the exit surface 1b. The second reflecting prism 4 has an incident surface 4a of a positive optical power, an exit surface 4b of a negative optical power, and a planar reflecting surface RL2 arranged on the optical path between the incident surface 4a and the exit surface 4b. In this embodiment, the reflecting surface RL1 formed on the first reflecting prism 1 and the reflecting surface RL2 formed on the second reflecting prism 4 are each adapted to bend an incident ray at about 90 degrees to direct the reflected ray toward the first lens element 2 and the plane parallel plate 5, respectively.

In this embodiment, whereas the first reflecting prism 1, the second reflecting prism 4, and the aperture stop (ST) are fixed, the first lens element 2 and the second lens element 3 are moved in the direction of the arrow B in FIG. 11 in focusing a subject from an infinite focal point to a closest focal point.

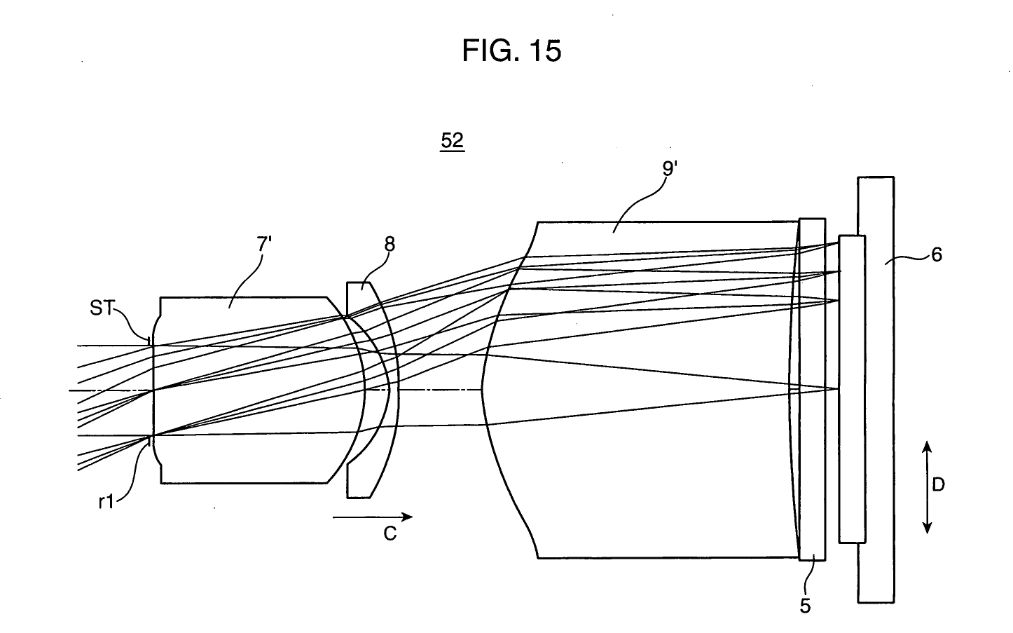

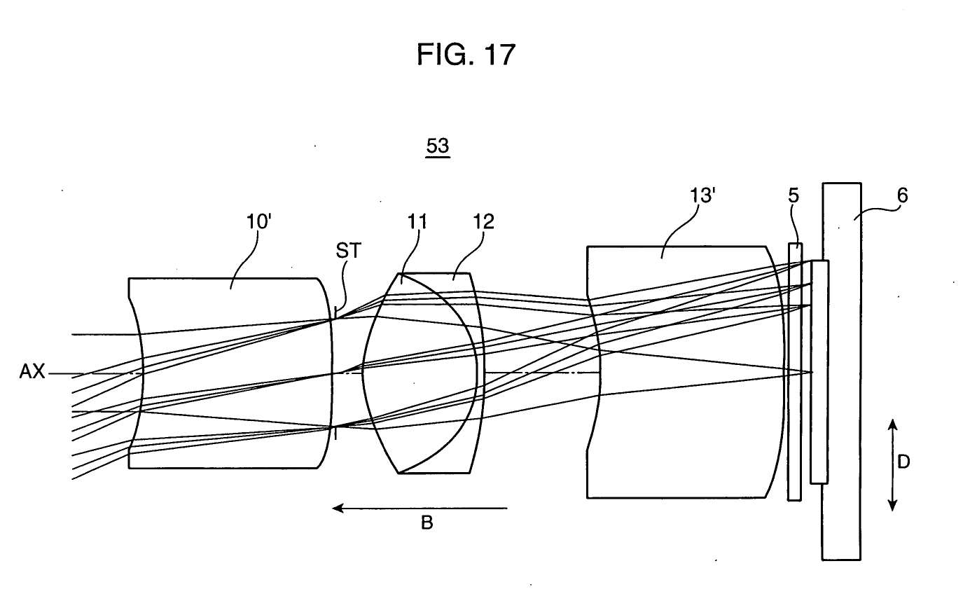

The surface denoted by ri (i=1, 2, 3, . . . ) shown in FIG. 12 indicates the i-th lens surface from the object side. In FIG. 12, the first lens element 2 is a bi-convex lens element, and the second lens element 3 is a negative meniscus lens element convex to the imaging side. In FIG. 12, elements corresponding to the first reflecting prism 1 and the second reflecting prism 4 shown in FIG. 11 are depicted as a first reflecting prism 1′ and a second reflecting prism 4′, considering that the arrangement in FIG. 12 uses lens elements having functions substantially equivalent to the functions of the first reflecting prism 1 and the second reflecting prism 4 in FIG. 11. The same definition is applied to the arrangements shown in FIGS. 15 and 17, which will be described below.

In the above construction, an incident ray from the object side or the subject side in FIG. 11 is incident onto the incident surface la of the first reflecting prism 1, bent at about 90 degrees on the reflecting surface RL1, and then incident onto the first lens element 2, the second lens element 3, and the incident surface 4a of the second reflecting prism 4 in this order. Subsequently, the incident ray is bent at about 90 degrees on the reflecting surface RL2, and goes out of the exit surface 4b for forming an optical image of the object. The optical image formed by these optical devices of the imaging optical system 51 propagates through the plane parallel plate 5 arranged in proximity to the second reflecting prism 4. At this time, the optical image is corrected in such a manner that a so-called alias noise generated in converting the optical image signal into an electrical signal by the image sensor 6 is minimized. The plane parallel plate 5 corresponds to an optical low-pass filter, an infrared cut filter, a cover glass for the image sensor, or an equivalent element.

Lastly, the optical image corrected by the plane parallel plate 5 is converted into an electrical signal by the image sensor 6. The electrical signal undergoes a predetermined digital image processing, an image compression processing or a like processing according to needs, and is recorded as a digital video signal into a memory device of the digital apparatus such as the camera phone 200 as shown in FIGS. 8A and 8B, the camera phone 220 as shown in FIG. 8C, the camera phone 300 as shown in FIGS. 9A and 9B, or the PDA 400 as shown in FIGS. 10A and 10B, or transmitted to another digital apparatus by a cable or wirelessly. Preferably, a cover glass is provided on the subject side relative to the incident surface 1a of the first reflecting prism 1 to keep the imaging optical system 51, particularly, the first reflecting prism 1 from being smeared.

In the following, the lens arrangements of the second embodiment and the third embodiment are described in this order referring to the drawings, as in the case of the first embodiment. It should be noted that elements in FIGS. 14 through 17 which are equivalent to those in FIGS. 11 and 12 are denoted by the same reference numerals.

### Second Embodiment

FIG. 14 is a cross-sectional view of an arrangement of an imaging optical system 52 as a second embodiment taken along a longitudinal direction of the optical axis (AX) in FIG. 14. As shown in FIG. 14, the imaging optical system 52 has, from the object side along the optical path, an aperture stop (ST) for regulating the light amount, a first reflecting prism 7 having a positive optical power as a whole, a first lens element 8 having a negative optical power, and a second reflecting prism 9 having a positive optical power as a whole.

The first reflecting prism 7 has an incident surface 7a of a positive optical power, an exit surface 7b of a positive optical power, and a planar reflecting surface RL3 arranged on the optical path between the incident surface 7a and the exit surface 7b. The second reflecting prism 9 has an incident surface 9a of a positive optical power, an exit surface 9b of a negative optical power, and a planar reflecting surface RL4 arranged on the optical path between the incident surface 9a and the exit surface 9b.

In this embodiment, whereas the aperture stop (ST), the first reflecting prism 7, and the second reflecting prism 9 are fixed, the first lens element 8 is moved in the direction shown by the arrow C in FIG. 14 in focusing a subject from an infinite focal point to a closest focal point. The first lens element 8 is a negative meniscus lens element convex to the imaging side.

### Third Embodiment

FIG. 16 is a cross-sectional view of an arrangement of an imaging optical system 53 as a third embodiment taken along a longitudinal direction of the optical axis (AX) in FIG. 16. As shown in FIG. 16, the imaging optical system 53 has, from the object side along the optical path, a first reflecting prism 10 having a positive optical power as a whole, an aperture stop (ST) for regulating the light amount, a first lens element 11 having a positive optical power, a second lens element 12 having a negative optical power, and a second reflecting prism 13 having a positive optical power as a whole.

The first reflecting prism 10 has an incident surface 10a of a negative optical power, an exit surface 10b of a positive optical power, and a planar reflecting surface RL5 arranged on the optical path between the incident surface 10a and the exit surface 10b. The second reflecting prism 13 has an incident surface 13a of a negative optical power, an exit surface 13b of a positive optical power, and a planar reflecting surface RL6 arranged on the optical path between the incident surface 13a and the exit surface 13b.

In this embodiment, whereas the first reflecting prism 10, the second reflecting prism 13, and the aperture stop (ST) are fixed, the first lens element 11 and the second lens element 12 are moved in the direction of the arrow B in FIG. 16 in focusing a subject from an infinite focal point to a closest focal point. The first lens element 11 is a biconvex lens element having a positive optical power, and the second lens element 12 is a negative meniscus lens element convex to the imaging side. The first lens element 11 and the second lens element 12 are cemented together.

As mentioned above in each of the first through the third embodiments, the imaging optical system 51 (52 or 53) is constructed in such a manner that the two reflecting prisms each adapted to bend an incident ray at about 90 degrees for reflection are arranged in a state that the incident surface of the reflecting prism disposed on the subject side along the optical path and the exit surface of the other reflecting prism are aligned substantially parallel to each other. This arrangement contributes to miniaturization of the imaging optical system.

Specifically, as shown in FIG. 12, for instance, if an imaging optical system 501 corresponding to the imaging optical system 51 shown in FIG. 11 is constructed without a reflecting prism, namely, without forming a reflecting surface for bending an incident ray at about 90 degrees for reflection, and the imaging optical system 501 is loaded in a camera phone corresponding to the camera phone 200 or the like, then, the thickness of the camera phone in the direction of the arrows B in FIG. 12, which corresponds to the thickness direction of the camera phone 200 shown in FIGS. 8A and 8B, is equal to or larger than the entire length of the imaging optical system 501. As a result, the thickness of the camera phone may be unduly increased, and the size of the camera phone 200 may be increased as a whole.

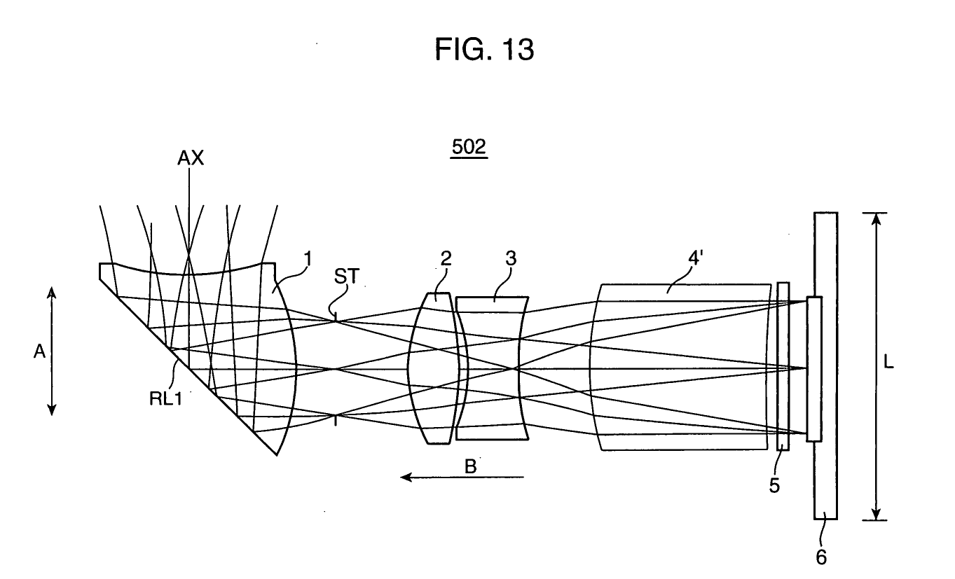

In view of the above, there may be proposed an arrangement of an imaging optical system 502 having one reflecting surface, as shown in FIG. 13. In this arrangement, a first reflecting prism 1 is provided in place of the lens element 1′ shown in FIG. 12. This arrangement may be advantageous in decreasing the thickness of the camera phone in the direction of the arrows A, which partly contributes to miniaturization of the camera phone, as compared with the arrangement shown in FIG. 12.

It should be noted, however, that the image sensor 6 is equipped with a packaging unit and an electrical wiring, and has a large size in the direction parallel with the light receiving surface of the image sensor 6 due to this arrangement. Therefore, the thickness of the camera phone is equal to or larger than the size of the image sensor 6 in the direction parallel with the light receiving surface, namely, is equal to or larger than the length L shown in FIG. 13. Thus, the arrangement as shown in FIG. 13 does not sufficiently contribute to miniaturization of the camera phone.

In view of the above, in the embodiment of the invention as shown in FIG. 11, the imaging optical system 51 provided with the two reflecting surfaces, namely, the first reflecting prism 1 and the second reflecting prism 4, in place of the lens elements 1′ and 4′ shown in FIG. 12, enables to miniaturize the camera phone 200 in the thickness direction thereof in light of the fact that the thickness direction of the imaging optical system 51 corresponds to the widthwise direction L′(<L) of the first reflecting prism 1 shown by the arrows A.

In the following, the imaging optical systems 51, 52, and 53 as the first through the third embodiments are described in detail referring to construction data, aberration diagrams and the like.

### PRACTICAL EXAMPLES

### Example 1

Construction data on the respective lens elements in the imaging optical system 51 as the first embodiment (Example 1) are described in Tables 1 and 2. It should be noted that the second reflecting prism corresponding to the imaging side prism is made of a plastic material, and the optical devices other than the second reflecting prism are made of glass in Examples 1 through 3.

TABLE 1

| | | AXIAL DISTANCE | | | |
|---|---|---|---|---|---|
| | | BETWEEN | | | |
| | | SURFACES | | | |
| LENS | RADIUS | INFINITE | CLOSEST | REFRAC- | |
| SURFACE | OF CUR- | FOCAL | FOCAL | TIVE | ABBE |
| No. | VATURE | POINT | POINT | INDEX | NUMBER |
| OBJECT | ∞ | ∞ | 500 | 1.53048 | 55.72 |
| r1* | −5.774 | 5.072 | | | |
| r2* | −4.181 | 1.000 | | | |
| r3 | ∞ | 1.880 | 1.483 | | |
| r4* | 4.406 | 1.300 | | 1.53048 | 55.72 |
| r5* | 5.943 | 0.256 | | | |
| r6* | −2.481 | 1.300 | | 1.58340 | 30.23 |
| r7* | −37.890 | 1.764 | 2.177 | | |
| r8* | 6.091 | 4.581 | | 1.53048 | 55.72 |
| r9* | 12.992 | 0.268 | | | |
| r10 | ∞ | 0.300 | 1.51680 | 65.26 | |
| r11 | ∞ | 0.500 | | | |
| r12 | ∞ | | | | |

TABLE 2

| ASPHER- | | | | | |
|---|---|---|---|---|---|
| ICAL | | | | | |
| SUR- | | | | | |
| FACE | K | A4 | A6 | A8 | A10 |
| 1 | 0 | 1.853E−03 | −1.433E−05 | −3.034E−06 | 1.441E−07 |
| 2 | 0 | 0.709E−03 | −2.834E−04 | 2.061E−05 | −3.885E−07 |
| 4 | 0 | 1.190E−02 | −8.105E−04 | −1.480E−04 | 2.893E−05 |
| 5 | 0 | 1.226E−02 | 1.226E−03 | −2.531E−03 | 4.682E−04 |
| 6 | 0 | 3.977E−02 | −3.632E−04 | −1.855−03 | 4.047E−04 |
| 7 | 0 | 2.062E−02 | 6.115E−04 | 2.407E−04 | −8.737E−06 |
| 8 | 0 | −3.634E−03 | 2.999E−04 | −7.055E−04 | −5.445E−08 |
| 9 | 0 | 1.913E−03 | −1.114E−03 | 1.113E−04 | −3.456E−06 |

Table 1 indicates, from the left-side column thereof, the respective lens surface numbers, radii of curvature (unit: mm) of the respective lens surfaces, distances (unit: mm) between the respective lens surfaces in the optical axis direction, namely, axial distances between the respective lens surfaces at the infinite focal point and the closest focal point, refractive indices of the respective lens elements, and the Abbe numbers of the respective lens elements. The axial distances are distances calculated on the presumption that the medium residing in the region between a pair of opposing planes including an optical plane and an imaging plane is the air. The value in each blank column regarding the axial distance between the lens surfaces at the closest focal point is the same as that in the corresponding left-side column at the infinite focal point. As shown in FIG. 12, the surface denoted by ri (i=1, 2, 3, . . . ) indicates the i-th lens surface from the object side on the optical path, and the surface ri marked with an asterisk (*) is an aspherical surface, namely, a refractive optical plane of an aspherical configuration or a plane having a refractive power substantially equivalent to the action of an aspherical plane in an optical path diagram substantially equivalent to the optical path diagram shown in FIG. 11.

Further, in Table 2, K represents a conical coefficient, and A4, A6, A8, and A10 respectively represent aspheric coefficients of 4th, 6th, 8th, and 10th orders.

Further, since the aperture stop (ST), both sides of the plane parallel plate 5, and the light receiving surface of the image sensor 6 are flat, respective radii of curvature thereof are infinite (∞).

The aspherical configuration of the lens surface is defined by the following conditional formula (3), wherein the apex of the lens surface is represented as the point of origin, and a local orthogonal coordinate system (x, y, z), with the direction from the object toward the image sensor being the positive z-axis direction is used.

$$z = \frac{c \cdot {h}^{2}}{1 + \sqrt{1 - ( 1 + k ) {c}^{2} \cdot {h}^{2}}} + A \cdot {h}^{4} + B \cdot {h}^{6} + C \cdot {h}^{8} + D \cdot {h}^{10} \qquad ( 3 )$$

where
z represents a z-axis displacement at the height position h relative to the apex of the lens surface,
h represents a height in a direction perpendicular to the z-axis (h²=x²+y²),
c represents a curvature near the apex of the lens surface (=1/radius of curvature),
A, B, C, and D respectively represent aspheric coefficients of 4th, 6th, 8th, and 10th orders, and
k represents a conical coefficient. As is obvious from the conditional formula (3), the radii of curvature of the respective aspheric lens elements in Table 1 each show a value approximate to the center of the corresponding lens element.

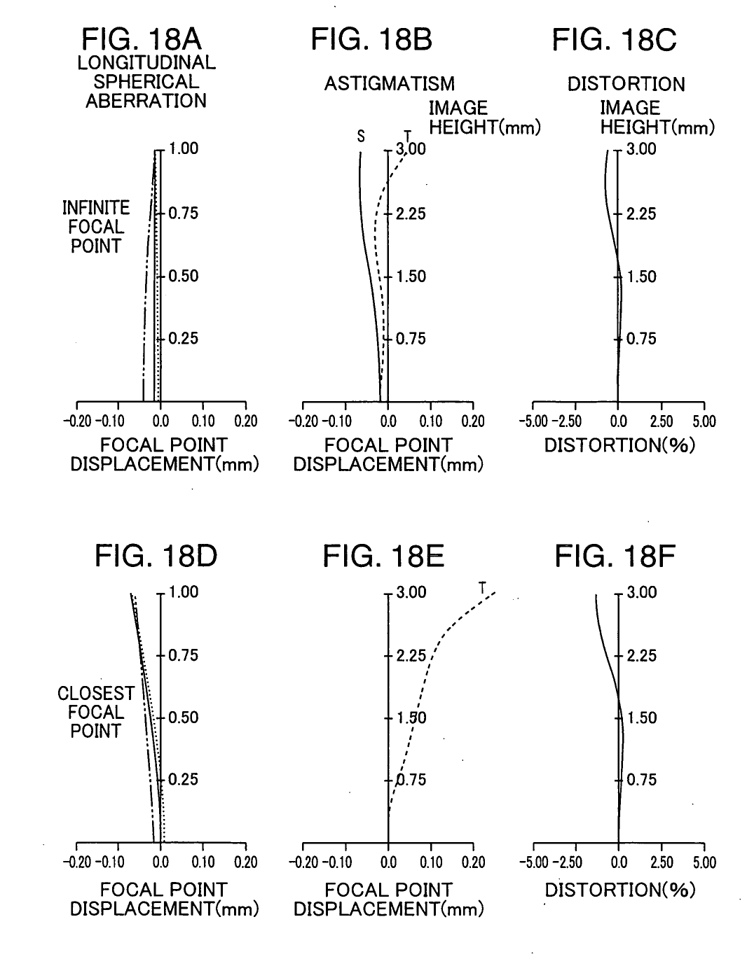

The spherical aberration (LONGITUDINAL SPHERICAL ABERRATION in FIGS. 18A and 18D), the astigmatism (ASTIGMATISM in FIGS. 18B and 18E), and the distortion aberration (DISTORTION in FIGS. 18C and 18F) of the optical system in Example 1 having the above lens arrangement and construction are shown in FIGS. 18A through 18F. Specifically, the respective aberrations at the infinite focal point and the closest focal point are shown in the upper row and the lower row in FIGS. 18A through 18F. Each of the horizontal axes in the spherical aberration diagrams shows a focal point displacement in the unit of mm. Each of the horizontal axes in the distortion aberration diagrams shows a distortion in terms of percentage. Each of the vertical axes in the spherical aberration diagrams shows a value standardized by the incident height, and each of the vertical axes in the astigmatism diagrams and the distortion aberration diagrams shows a height of an optical image or an image height in the unit of mm.

In the spherical aberration diagrams, aberrations in case of using light of three different wavelengths are shown, wherein the broken lines represent aberrations in a red ray (wavelength: 656.28 nm), the solid lines represent aberrations in a yellow ray (so-called “d-ray” having a wavelength of 587.56 nm), and the two-dotted-chain lines represent aberrations in a blue ray (wavelength: 435.84 nm). In the astigmatism diagrams, the dashed lines “T” and the solid lines “S” respectively represent displacements (unit: mm, represented by the horizontal axes) of a tangential (meridional) plane and a sagittal (radial) plane near the apex of the lens surface in the direction of the optical axis (AX). Further, the astigmatism diagrams and the distortion aberration diagrams show results of using the yellow ray or d-ray.

As is obvious from FIGS. 18A through 18F, the imaging optical system 51 in Example 1 exhibits superior optical characteristics, wherein the spherical aberration, the astigmatism, and the distortion aberration are significantly small both at the infinite focal point and the closest focal point. The focal length (unit: mm), the F-number, and the maximum image height at the infinite focal point in Example 1 are shown in Table 7. Table 7 shows that Example 1 provides a fast optical system.

### Example 2

Construction data on the respective lens elements in the imaging optical system 52 as the second embodiment (Example 2) are described in Tables 3 and 4.

TABLE 1

| | | AXIAL DISTANCE | | | |
|---|---|---|---|---|---|
| | | BETWEEN | | | |
| | | SURFACES | | | |
| LENS | RADIUS | INFINITE | CLOSEST | REFRAC- | |
| SURFACE | OF CUR- | FOCAL | FOCAL | TIVE | ABBE |
| No. | VATURE | POINT | POINT | INDEX | NUMBER |
| OBJECT | ∞ | ∞ | 200 | | |
| r1 | ∞ | 0.000 | | | |
| r2* | 17.833 | 4.371 | | 1.58913 | 61.11 |
| r3* | −2.135 | 0.482 | 0.544 | | |
| r4* | −1.399 | 0.176 | | 1.58340 | 30.23 |
| r5* | −14.772 | 1.722 | 1.660 | | |
| r6* | 2.535 | 6.387 | | 1.53048 | 55.72 |
| r7* | 47.000 | 0.205 | | | |
| r8 | ∞ | 0.533 | | 1.51680 | 65.26 |
| r9 | ∞ | 0.280 | | | |
| r10 | ∞ | | | | |

Table 4

| ASPHERICAL | | | | | | |
|---|---|---|---|---|---|---|
| SURFACE | K | A4 | A6 | A8 | A10 | A12 |
| 2 | −314.18159 | 3.075E−03 | 4.414E−03 | −8.388E−03 | 4.074E−03 | |
| 3 | −3.774837 | −8.217E−03 | −8.113E−03 | 1.411E−03 | 5.197E−03 | |
| 4 | −3.207117 | −8.561E−02 | 2.689E−03 | −1.388E−03 | −1.366E−03 | 1.940E−04 |
| 5 | 39.078736 | −4.528E−02 | 8.458E−03 | −8.667E−04 | 3.170E−05 | 4.181E−07 |
| 6 | −4.108197 | 2.180E−03 | −6.884E−04 | 6.605E−05 | −4.774E−06 | 1.244E−07 |
| 7 | −1.47498E+27 | 6.684E−03 | 1.328E−04 | −1.663E−04 | 1.858E−05 | −5.905E−07 |

Similarly to Table 2, in Table 4, K represents a conical coefficient, and A4, A6, A8, A10, and A12 respectively represent aspheric coefficients of 4th, 6th, 8th, 10th, and 12th orders.

### Example 3

Further, construction data on the respective lens elements in the imaging optical system 53 as the third embodiment (Example 3) are described in Tables 5 and 6.

TABLE 1

| | | AXIAL DISTANCE | | | |
|---|---|---|---|---|---|
| | | BETWEEN | | | |
| | | SURFACES | | | |
| LENS | RADIUS | INFINITE | CLOSEST | REFRAC- | |
| SURFACE | OF CUR- | FOCAL | FOCAL | TIVE | ABBE |
| No. | VATURE | POINT | POINT | INDEX | NUMBER |
| OBJECT | ∞ | ∞ | 500 | | |
| r1* | −5.168 | 4.939 | | 1.58340 | 30.23 |
| r2* | −5193.156 | 0.100 | | | |
| r3 | ∞ | 0.822 | 0.743 | | |
| r4* | 2.852 | 3.000 | | 1.53048 | 55.72 |
| r5 | 2.753 | 0.240 | | 1.58340 | 30.23 |
| r6* | −16.022 | 3.073 | 3.171 | | |
| r7* | −15.591 | 5.003 | | 1.58340 | 30.23 |
| r8* | −54.952 | 0.100 | | | |
| r9 | ∞ | 0.300 | | 1.51680 | 65.26 |
| r10 | ∞ | 0.282 | | | |
| r11 | ∞ | | | | |

TABLE 6

| ASPHERICAL | | | | | |
|---|---|---|---|---|---|
| SURFACE | K | A | B | C | D |
| 1 | −0.482825 | 2.38E−03 | −1.83E−04 | 3.60E−06 | −3.04E−06 |
| 2 | −0.87E+36 | −7.35E−03 | 2.77E−04 | 3.51E−04 | −7.26E−05 |
| 4 | −2.399317 | 4.51E−04 | 1.94E−04 | 1.46E−06 | −6.10E−06 |
| 6 | 5.340723 | −1.91E−03 | −2.39E−04 | −1.12E−06 | −2.36E−07 |
| 7 | 48.069031 | −9.07E−03 | −1.22E−04 | −2.87E−06 | −2.77E−05 |
| 8 | −4.09E+25 | −3.52E−03 | −7.01E−04 | 1.23E−04 | −6.10E−06 |

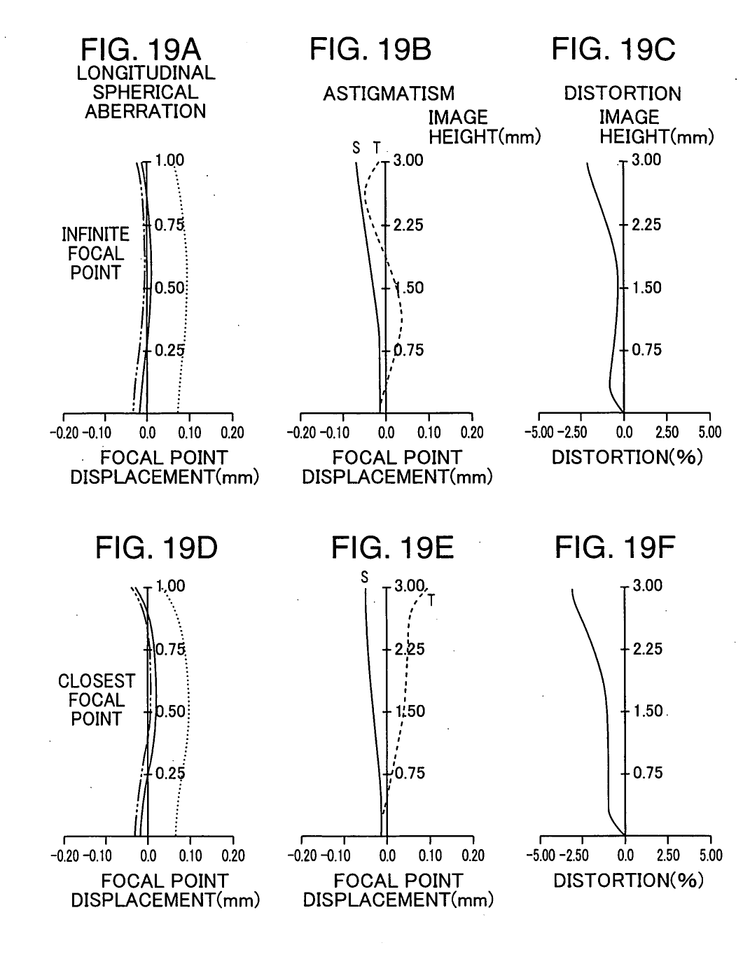

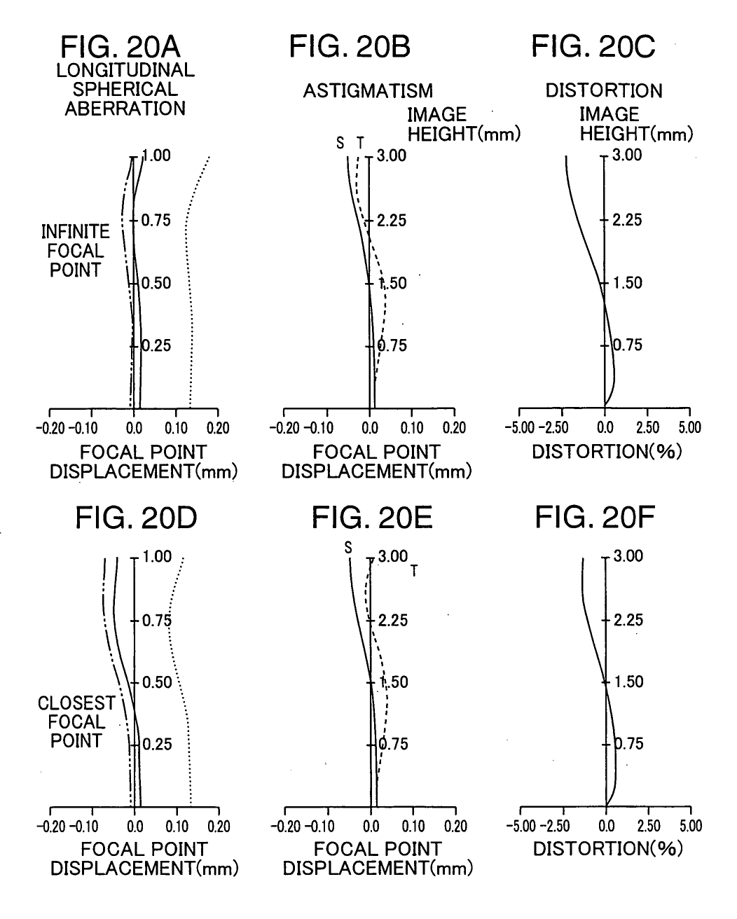

FIGS. 19A through 19F are aberration diagrams of Example 2, and FIGS. 20A through 20F are aberration diagrams of Example 3. Specifically, the sperical aberration (LONGITUDINAL SPHERICAL ABERRATION in FIGS. 19A, 19D, 20A, and 20D), the astigmatism (ASTIGMATISM in FIGS. 19B, 19E, 20B, and 20E), and the distortion aberration (DISTORTION in FIGS. 19C, 19F, 20C, and 20F) of the optical systems in Examples 2 and 3 are shown in FIGS. 19A through 20F. As is obvious from FIGS. 19A through 20F, the imaging optical systems 52 and 53 in Examples 1 and 2 exhibit superior optical characteristics, wherein the spherical aberration, the astigmatism, and the distortion aberration are significantly small both at the infinite focal point and the closest focal point. The focal length (unit: mm) and the F-number at the infinite focal point in Examples 2 and 3 are shown in Table 7, as well as Example 1. Table 7 shows that Examples 2 and 3 each provide a fast optical system, as well as Example 1.

TABLE 7

| | FOCAL LENGTH | F | MAXIMUM IMAGE |
|---|---|---|---|
| | (mm) | NUMBER | HEIGHT (mm) |
| EXAMPLE 1 | 6.82 | 3.5 | 3 |
| EXAMPLE 2 | 6.4 | 3.6 | 3 |
| EXAMPLE 3 | 6.4 | 3 | 3 |

The arrangement relation between the second prism 4 (9 or 13) and the image sensor 6 in Examples 1 through 3 is defined as shown in Table 8 to miniaturize the imaging optical system 51 (52 or 53). Specifically, the height a (unit: mm) of the light receiving surface of the image sensor 6 on the plane where the optical path of the image sensor 6 is folded, which corresponds to the plane of FIG. 11 (FIG. 14 or FIG. 16), the distance d (unit: mm) between the exit surface 4b (9b or 13b) of the second reflecting prism 4 (9 or 13) and the light receiving surface of the image sensor 6, and the respective calculation results of the conditional formula (1) in Examples 1 through 3 are as shown in Table 8.

TABLE 8

| | HEIGHT (a) OF LIGHT RECEIVING | DISTANCE (d) BETWEEN EXIT | |
|---|---|---|---|
| | SURFACE OF IMAGE SENSOR | SURFACE OF SECOND REFLECTING | |
| | ON PLANE WHERE OPTICAL | PRISM AND LIGHT RECEIVING | |
| | PATH IS FOLDED | SURFACE OF IMAGE SENSOR | d/a |
| EXAMPLE 1 | 3.600 | 1.052 | 0.292 |
| EXAMPLE 2 | 3.600 | 1.018 | 0.283 |
| EXAMPLE 3 | 3.600 | 0.682 | 0.189 |

Further, in Examples 1 through 3, the second reflecting prisms 4, 9, and 13 respectively satisfying the parameters as shown in Table 9 are adopted to optimize the size or the length of the second reflecting prisms 4, 9 and 13. Specifically, the refractive index n of the second reflecting prism 4 (9 or 13), the distance t of the principal ray, the exit pupil distance p, and the respective calculation results of the conditional formula (2) in Examples 1 through 3 are as shown in Table 9, wherein the units of the parameters t and p are mm.

TABLE 9

| | | DISTANCE | | |
|---|---|---|---|---|
| | | (t) OF | | |
| | REFRACTIVE | PRINCIPAL | EXIT PUPIL | |
| | INDEX (n) | RAY | DISTANCE (p) | (t · n)/p |
| EXAMPLE 1 | 1.530 | 4.581 | −8.473 | −0.827 |
| EXAMPLE 2 | 1.530 | 6.387 | −22.690 | −0.431 |
| EXAMPLE 3 | 1.583 | 5.003 | −9.387 | −0.844 |

The imaging optical systems 51, 52, and 53 in Examples 1 through 3 adopt the parameters as shown in Tables 8 and 9. This arrangement enables to reduce the size of the imaging optical system 51 (52 or 53) in the thickness direction thereof corresponding to the direction of the arrows L′ in FIG. 11, which securely contributes to miniaturization of the digital apparatus in the thickness direction thereof.

### Description on Embodiments of Zoom Optical System

Next, embodiments of the zoom optical system 110 as shown in FIG. 7, specifically, exemplified arrangements of the zoom optical system 110 constituting the imaging lens device 206 to be loaded in the camera phone 200 as shown in FIGS. 8A and 8B, the camera phone 220 as shown in FIG. 8C, the camera phone 300 as shown in FIGS. 9A and 9B, or in the PDA 400 as shown in FIGS. 10A and 10B are described referring to the drawings.

### Fourth Embodiment

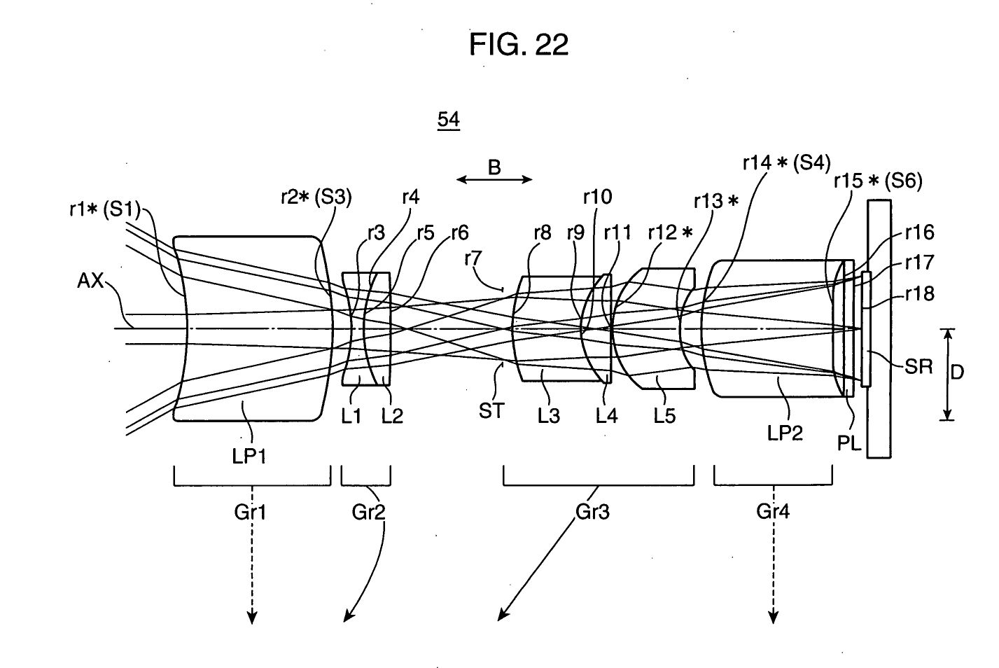

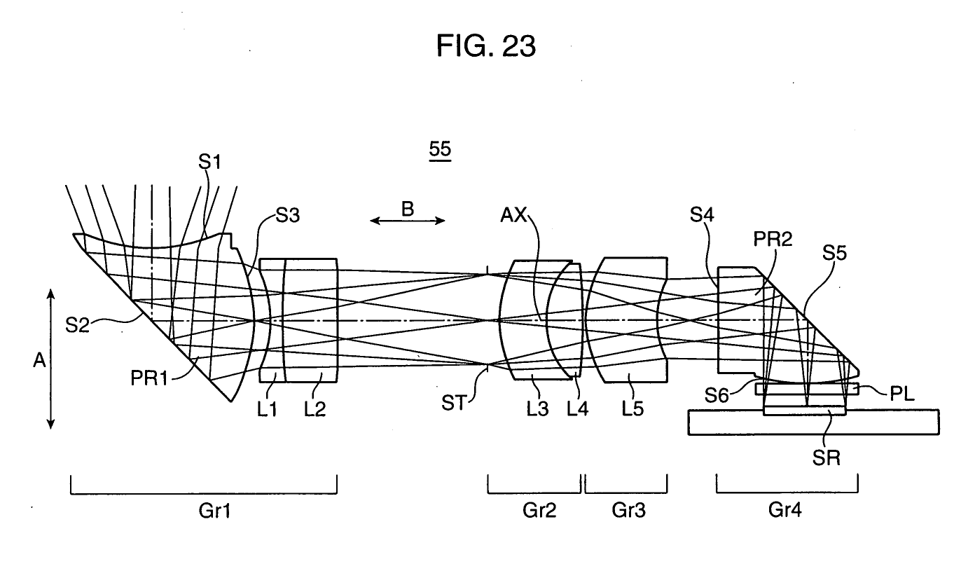

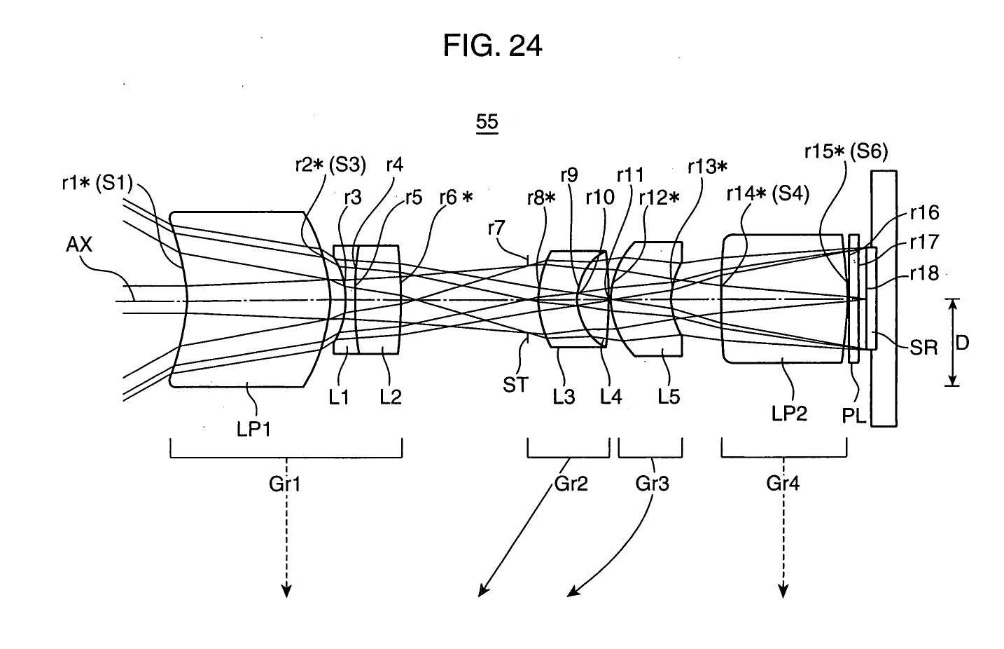

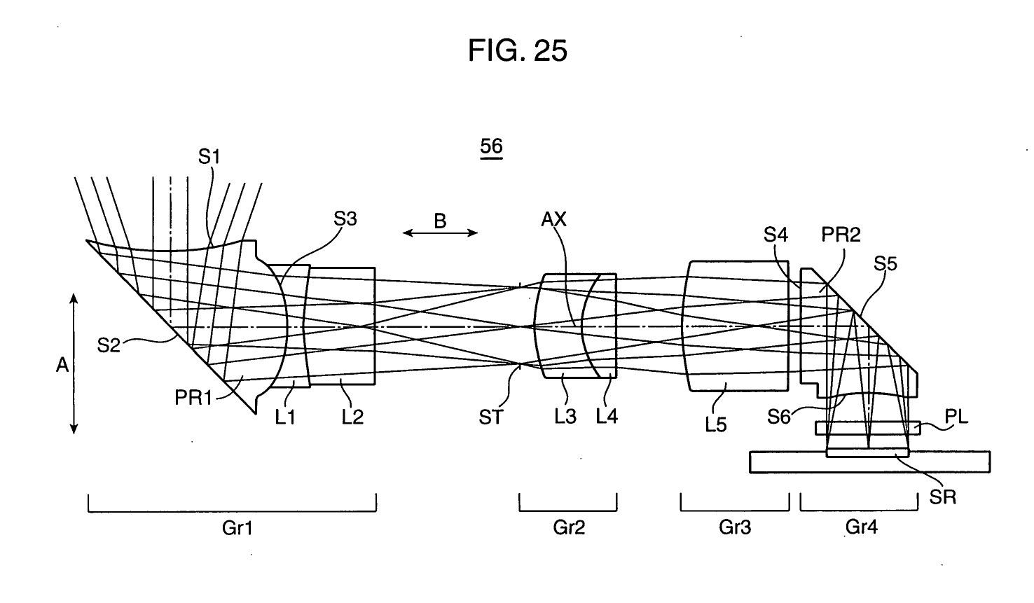

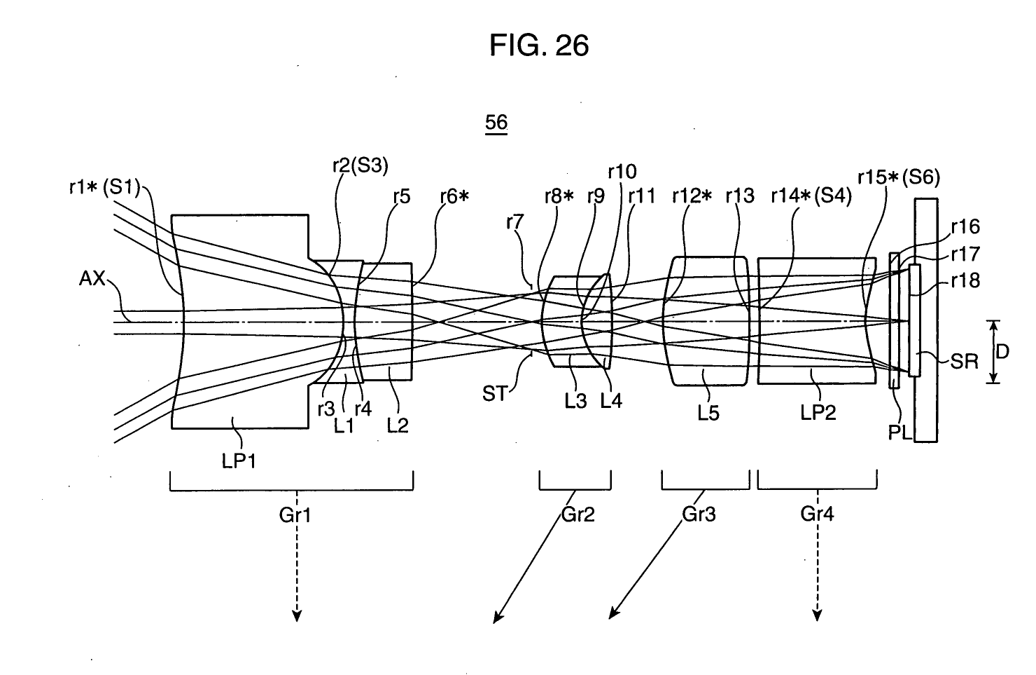

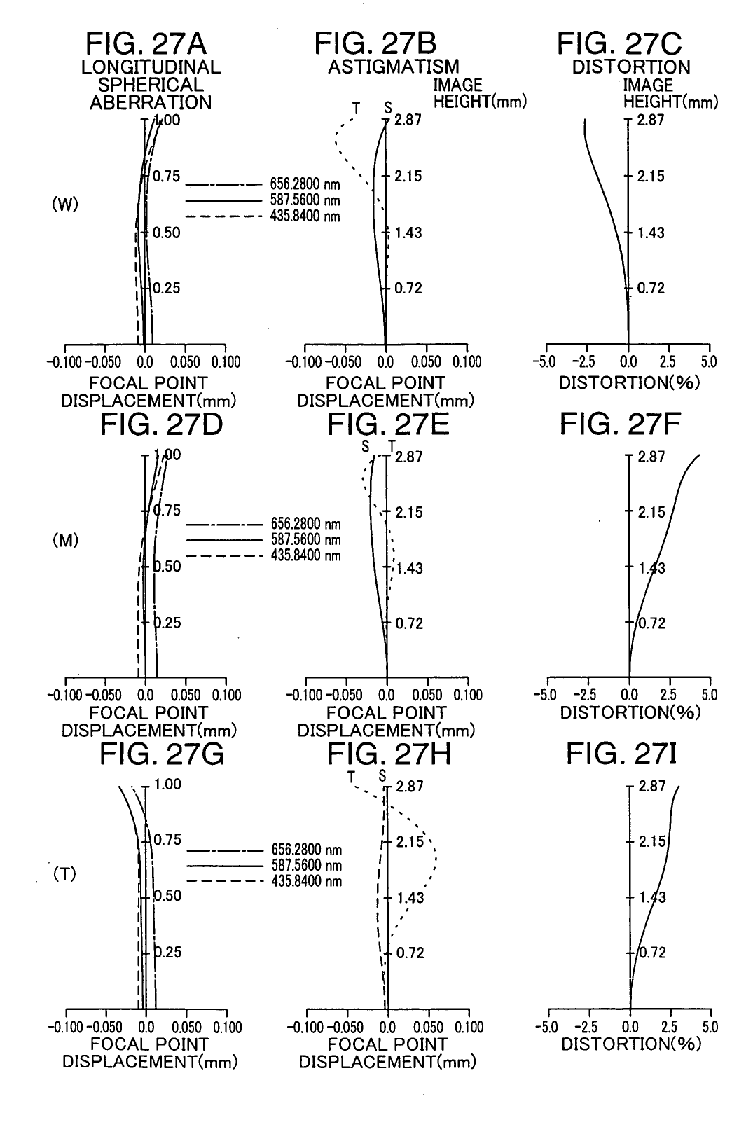

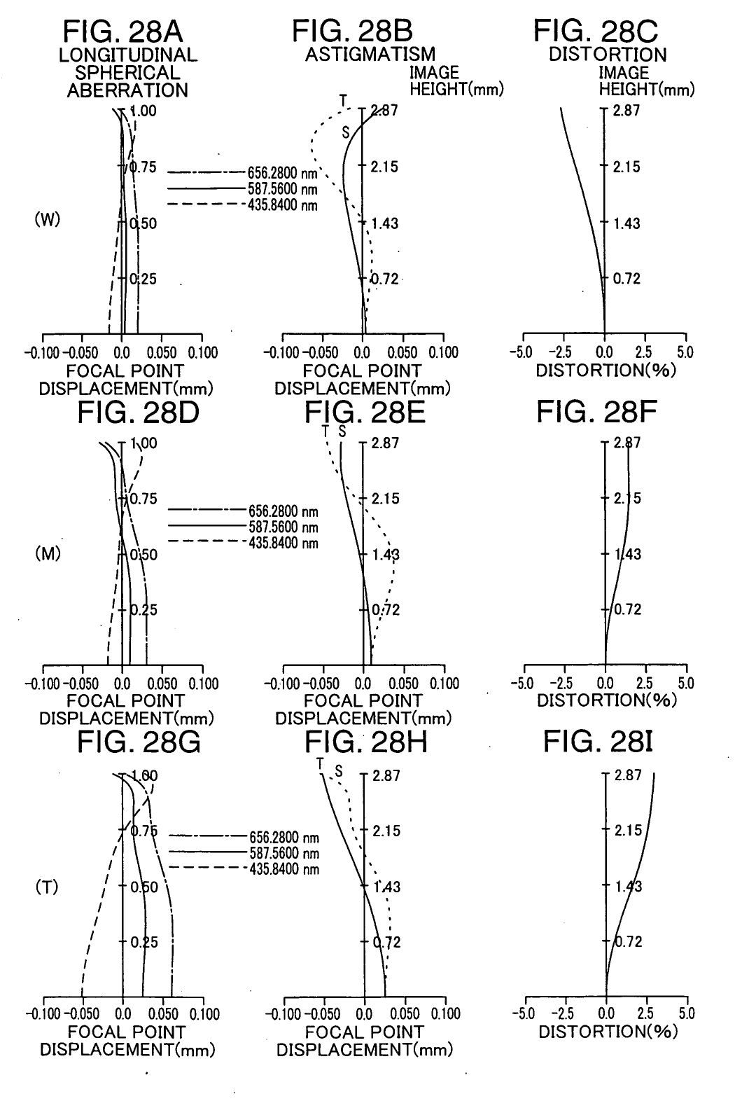

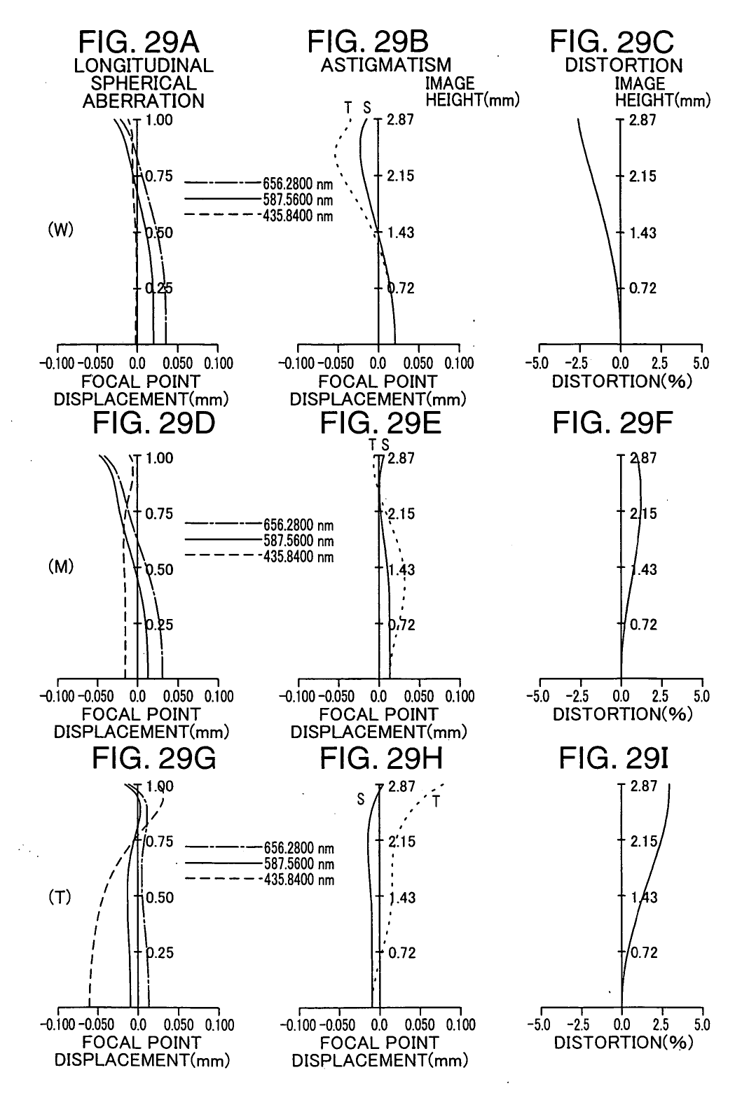

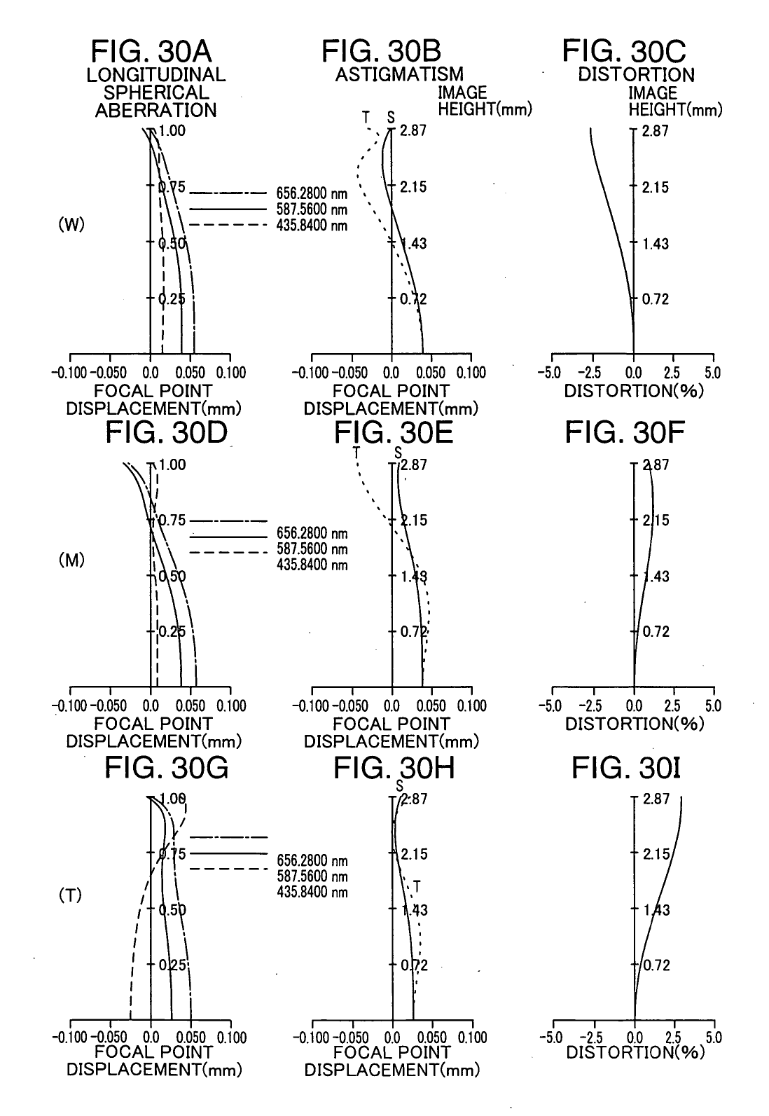

FIG. 21 is a cross-sectional view of an arrangement of a zoom optical system 54 as a fourth embodiment taken along a longitudinal direction of the optical axis (AX) in FIG. 21. FIG. 21 shows an arrangement of optical devices of the zoom optical system 54 with an infinite focal length. FIG. 21, as well as FIGS. 22 through 27 each schematically show an optical path along which an incident ray from the object side propagates, with its axis serving as the optical axis (AX).

The zoom optical system 54 comprises, from the object side along the optical path, a first lens group (Gr1) including a first reflecting prism (PR1), which corresponds to the incident side prism 101 in FIG. 7, and has a negative optical power as a whole; a second lens group (Gr2) having a negative optical power as a whole and including a cemented lens element consisting of a biconcave lens element (L1) having a negative optical power and a biconvex lens element (L2) having a positive optical power; a third lens group (Gr3) including an aperture stop (ST), having a positive optical power as a whole, and including a cemented lens element consisting of a negative meniscus lens element (L3) convex to the imaging side and a biconvex positive lens element (L4), and a positive meniscus lens element (L5) convex to the object side; and a fourth lens group (Gr4) having a second reflecting prism (PR2), which corresponds to the imaging side prism 102 in FIG. 7, and has a positive optical power. The optical axes of the second lens group (Gr2) and the third lens group (Gr3) are designed to be aligned with the axis (AX) of the optical path between the first reflecting prism (PR1) and the second reflecting prism (PR2). A plane parallel plate (PL) and an image sensor (SR) are arranged on the imaging side of the second reflecting prism (PR2). The image sensor (SR) has an aspect ratio of 3:4, for instance.

Further, the first reflecting prism (PR1) has an incident surface (S1) of a negative optical power, an exit surface (S3) of a positive optical power, and a planar reflecting surface (S2) arranged on the optical path between the incident surface (S1) and the exit surface (S3). The second reflecting prism (PR2) has an incident surface (S4) of a positive optical power, an exit surface (S6) of a negative optical power, and a planar reflecting surface (S5) arranged on the optical path between the incident surface (S4) and the exit surface (S6). In this embodiment, the reflecting surface (S2) formed on the first reflecting prism (PR1) and the reflecting surface (S5) formed on the second reflecting prism (PR2) are adapted to bend an incident ray at about 90 degrees to direct the reflected ray toward the second lens group (Gr2) and the plane parallel plate (PL), respectively.

The zoom optical system 54 shown in FIG. 21 is a zoom optical system in which an incident ray is bent in the shorter side direction of the image sensor (SR). In other words, transverse directions in FIG. 21 correspond to the shorter side direction of the image sensor (SR), and the direction of the arrows A corresponds to the thickness direction of the camera phone 200 as shown in FIGS. 8A and 8B or the camera phone 220 as shown in FIG. 8C.

FIG. 22 is an illustration showing a zoom optical system equivalent to the zoom optical system 54 in FIG. 21, wherein lens elements (LP1, LP2) having functions substantially equivalent to the functions of the first reflecting prism (PR1) and the second reflecting prism (PR2) in FIG. 21 are used in place of the first reflecting prism (PR1) and the second reflecting prism (PR2) in FIG. 21. The surface denoted by ri (i=1, 2, 3, . . . ) in FIG. 22 indicates the i-th lens surface from the object side, and the surface ri marked with an asterisk (*) is an aspherical surface. The direction of the arrows D in FIG. 22 corresponds to the longer side direction of the image sensor (SR).

The number of the lens elements constituting the cemented lens element is not the number of the cemented lens element itself but is the number of single lens elements constituting the cemented lens element. For instance, if the cemented lens element is constituted of three single lens elements, the number of the lens elements constituting the cemented lens element is three.

In the above construction, an incident ray from the object side or the subject side in FIG. 21 is incident onto the incident surface (S1) of the first reflecting prism (PR1), bent at about 90 degrees on the reflecting surface (S2), and goes out of the exit surface (S3). Then, the exit ray propagates through the second lens group (Gr2) and the third lens group (Gr3), and is incident onto the incident surface (S4) of the second reflecting prism (PR2). Then, the incident ray is bent at about 90 degrees on the reflecting surface (S5), and goes out of the exit surface (S6) for forming an optical image of an object. The optical image propagates through the plane parallel plate (PL) arranged in proximity to the second reflecting prism (PR2). At this time, the optical image is corrected in such a manner that a so-called alias noise generated in converting the optical image signal into an electrical signal by the image sensor (SR) is minimized. The plane parallel plate (PL) corresponds to an optical low-pass filter, an infrared cut filter, a cover glass for the image sensor, or an equivalent element.

Lastly, the optical image corrected by the plane parallel plate (PL) is converted into an electrical signal by the image sensor (SR). The electrical signal undergoes a predetermined digital image processing, an image compression processing or a like processing according to needs, and is recorded, as a digital video signal, into a memory device of the digital apparatus such as the camera phone 200 as shown in FIGS. 8A and 8B, the camera phone 220 as shown in FIG. 8C, the camera phone 300 as shown in FIGS. 9A and 9B, or the PDA 400 as shown in FIGS. 10A and 10B, or transmitted to another digital apparatus by a cable or wirelessly.

Hereinafter, an intermediate point between the wide angle limit (W) where the focal length is the shortest, namely, the angle of view is the largest, and the telephoto limit (W) where the focal length is the longest, namely, the angle of view is the smallest is called as “mid point (M)”.

In the lens arrangement of the fourth embodiment as shown in FIG. 21, the first reflecting prism (PR1) and the second reflecting prism (PR2) are fixed, the second lens group (Gr2) makes a U-turn in such a manner that the second lens group (Gr2) comes closest to the imaging side around the mid point (M), and the third lens group (Gr3) is substantially linearly moved toward the object side during zooming from the wide angle limit (W) to the telephoto limit (T) as shown in FIG. 22. At this time, both the second lens group (Gr2) and the third lens group (Gr3) are moved in the optical axis direction of the lens groups for zooming. It should be noted that the moving direction, the moving amount, and other parameter of the lens groups are changeable depending on the optical power of the lens groups or the like.

It is desirable to fix the first reflecting prism (PR1) and the second reflecting prism (PR2) and move at least one of the second lens group (Gr2) and the third lens group (Gr3) in parallel to the optical axis, namely, in the direction of the arrows B in FIG. 21 in focusing a subject from an infinite focal point to a closest focal point. This arrangement enables focusing without changing the thickness of the entirety of the zoom optical system 54 in the direction of the arrows A in FIG. 21.

In the following, as in the case of the fourth embodiment, the lens arrangements of the fifth embodiment and the sixth embodiment are described in this order referring to the drawings. Elements in FIGS. 23 and 25 equivalent to those in FIG. 21 are denoted by the same references, and elements in FIGS. 24 and 26 equivalent to those in FIG. 22 are denoted by the same reference numerals. It should be noted, however, that the elements of the like reference numerals are not necessarily identical to each other. For instance, although the first reflecting prisms in FIGS. 21, 23, and 25 are denoted by the same reference numeral (PR1), this does not mean that the first reflecting prisms in FIGS. 21, 23, and 25 are identical to each other.

### Fifth Embodiment

FIG. 23 is a cross-sectional view of an arrangement of a zoom optical system 55 as the fifth embodiment taken along a longitudinal direction of the optical axis (AX) in FIG. 23. FIG. 23 shows an arrangement of optical devices with an infinite focal length.

The zoom optical system 55 comprises, from the object side along the optical path, a first lens group (Gr1) including a first reflecting prism (PR1) having a negative optical power, and a cemented lens element having a negative optical power as a whole and consisting of a biconcave negative lens element (L1) and a biconvex positive lens element (L2); a second lens group (Gr2) including an aperture stop (ST), having a negative optical power as a whole, and including a cemented lens element consisting of a negative meniscus lens element (L3) convex to the object side and a biconvex positive lens element (L4); a third lens group (Gr3) having a positive meniscus lens element (L5) convex to the object side; and a fourth lens group (Gr4) having a second reflecting prism (PR2) of a positive optical power. The optical axes of the second lens group (Gr2) and the third lens group (Gr3) are designed to be aligned with the axis (AX) of the optical path between the first reflecting prism (PR1) and the second reflecting prism (PR2). A plane parallel plate (PL) and an image sensor (SR) are arranged on the imaging side of the second reflecting prism (PR2).

Further, the first reflecting prism (PR1) has an incident surface (S1) of a negative optical power, an exit surface (S3) of a positive optical power, and a planar reflecting surface (S2) arranged on the optical path between the incident surface (S1) and the exit surface (S3). The second reflecting prism (PR2) has an incident surface (S4) and an exit surface (S6) both having a positive optical power, and a planar reflecting surface (S5) arranged on the optical path between the incident surface (S4) and the exit surface (S6). In this embodiment, the reflecting surface (S2) formed on the first reflecting prism (PR1) and the reflecting surface (S5) formed on the second reflecting prism (PR2) are adapted to bend an incident ray at about 90 degrees to direct the reflected ray toward the second lens group (Gr2) and the plane parallel plate (PL), respectively.

The zoom optical system 55 shown in FIG. 23 is a zoom optical system in which an incident ray is bent in the shorter side direction of the image sensor (SR), as in the case of FIG. 21. The direction of the arrows A in FIG. 23 corresponds to the thickness direction of the camera phone 200 as shown in FIGS. 8A and 8B or the camera phone 220 as shown in FIG. 8C.

FIG. 24 is an illustration showing a zoom optical system equivalent to the zoom optical system 55 in FIG. 23, wherein lens elements having functions substantially equivalent to the functions of the first reflecting prism (PR1) and the second reflecting prism (PR2) in FIG. 23 are used in place of the first reflecting prism (PR1) and the second reflecting prism (PR2) in FIG. 23. The direction of the arrows D in FIG. 24 corresponds to the longer side direction of the image sensor (SR).

In the above construction, an incident ray from the object side in FIG. 23 is bent on the reflecting surface (S2) of the first reflecting prism (PR1) at about 90 degrees, propagates through the second lens group (Gr2) and the third lens group (Gr3), and is bent on the reflecting surface (S5) of the second reflecting prism (PR2) at about 90 degrees for forming an optical image of a subject onto the light receiving surface of the image sensor (SR).

In the lens arrangement of the fifth embodiment as shown in FIG. 23, the first reflecting prism (PR1) and the second reflecting prism (PR2) are fixed, the second lens group (Gr2) is substantially linearly moved toward the object side, and the third lens group (Gr3) is also moved toward the object side with its distance to the second lens group (Gr2) being changed during zooming from the wide angle limit (W) to the telephoto limit (T) as shown in FIG. 24. At this time, both the second lens group (Gr2) and the third lens group (Gr3) are moved in the optical axis direction of the lens groups for zooming.

It is desirable to fix the first reflecting prism (PR1) and the second reflecting prism (PR2), and to move at least one of the second lens group (Gr2) and the third lens group (Gr3) in parallel to the optical axis, namely, in the direction of the arrows B in FIG. 23 in focusing a subject from an infinite focal point to a closest focal point. This arrangement enables focusing without changing the thickness of the entirety of the zoom optical system 55 in the direction of the arrows A in FIG. 23.

### Sixth Embodiment

FIG. 25 is a cross-sectional view of an arrangement of a zoom optical system 56 as the sixth embodiment taken along a longitudinal direction of the optical axis (AX) in FIG. 25. FIG. 25 shows an arrangement of optical devices with an infinite focal length.

The zoom optical system 56 comprises, from the object side along the optical path, a first lens group (Gr1) having a negative optical power as a whole, and including a first reflecting prism (PR1), and a cemented lens element consisting of a biconcave negative lens element (L1) and a biconvex positive lens element (L2); a second lens group (Gr2) having a positive optical power as a whole, and including an aperture stop (ST), and a cemented lens element consisting of a negative meniscus lens element (L3) convex to the object side and a biconvex positive lens element (L4); a third lens group (Gr3) having a positive meniscus lens element (L5) convex to the object side; and a fourth lens group (Gr4) including a second reflecting prism (PR2) of a negative optical power. The optical axes of the second lens group (Gr2) and the third lens group (Gr3) are designed to be aligned with the axis (AX) of the optical path between the first reflecting prism (PR1) and the second reflecting prism (PR2). A plane parallel plate (PL) and an image sensor (SR) are arranged on the imaging side of the second reflecting prism (PR2).

Further, the first reflecting prism (PR1) has an incident surface (S1) of a negative optical power, an exit surface (S3) of a positive optical power, and a planar reflecting surface (S2) arranged on the optical path between the incident surface (S1) and the exit surface (S3). The second reflecting prism (PR2) has an incident surface (S4) of a positive optical power, an exit surface (S6) of a negative optical power, and a planar reflecting surface (S5) arranged on the optical path between the incident surface (S4) and the exit surface (S6). In this embodiment, the reflecting surface (S2) formed on the first reflecting prism (PR1) and the reflecting surface (S5) formed on the second reflecting prism (PR2) are adapted to bend an incident ray at about 90 degrees to direct the reflected ray toward the second lens group (Gr2) and the plane parallel plate (PL), respectively.

The zoom optical system 56 shown in FIG. 25 is a zoom optical system in which an incident ray is bent in the shorter side direction of the image sensor (SR), as in the cases of FIGS. 21 and 23. The direction of the arrows A corresponds to the thickness direction of the camera phone 200 as shown in FIGS. 8A and 8B or the camera phone 220 as shown in FIG. 8C.

FIG. 26 is an illustration showing a zoom optical system equivalent to the zoom optical system 56 in FIG. 25, wherein lens elements having functions substantially equivalent to the functions of the first reflecting prism (PR1) and the second reflecting prism (PR2) in FIG. 25 are used in place of the first reflecting prism (PR1) and the second reflecting prism (PR2) in FIG. 25. The direction of the arrows D in FIG. 26 corresponds to the longer side direction of the image sensor (SR).

In the above construction, an incident ray from the object side in FIG. 25 is bent on the reflecting surface (S2) of the first reflecting prism (PR1) at about 90 degrees, propagates through the second lens group (Gr2) and the third lens group (Gr3), and is bent on the reflecting surface (S5) of the second reflecting prism (PR2) at about 90 degrees for forming an optical image of a subject onto the light receiving surface of the image sensor (SR).

In the lens arrangement of the sixth embodiment as shown in FIG. 25, the first reflecting prism (PR1) and the second reflecting prism (PR2) are fixed, the second lens group (Gr2) is moved toward the object side, and the third lens group (Gr3) is also moved toward the object side with its distance to the second lens group (Gr2) being changed during zooming from the wide angle limit (W) to the telephoto limit (T) as shown in FIG. 26. At this time, both the second lens group (Gr2) and the third lens group (Gr3) are moved in the optical axis direction of the lens groups for zooming.

It is desirable to fix the first reflecting prism (PR1) and the second reflecting prism (PR2), and to move at least one of the second lens group (Gr2) and the third lens group (Gr3) in parallel to the optical axis, namely, in the direction of the arrows B in FIG. 25 in focusing a subject from an infinite focal point to a closest focal point. This arrangement enables focusing without changing the thickness of the entirety of the zoom optical system 56 in the direction of the arrows A in FIG. 25.

In the fourth to the sixth embodiments as described above, as in the case of the first through the third embodiments, preferably, a cover glass may be provided on the subject side relative to the incident surface of the first reflecting prism 1 to keep the zoom optical system, particularly, the first reflecting prism (PR1) from being smeared. Since the thickness of the cover glass is generally small, there is no or less likelihood that providing the cover glass may unduly increase the thickness of the entirety of the optical system.

In the following, the zoom optical systems 54, 55, and 56 as the fourth through the sixth embodiments are described in detail referring to construction data, aberration diagrams and the like.

### PRACTICAL EXAMPLES

### Example 4

Construction data on the respective lens elements in the zoom optical system 54 as the fourth embodiment (Example 4) are described in Tables 10 and 11. It should be noted that the second reflecting prism corresponding to the imaging side prism is made of a plastic material, and the optical devices other than the second reflecting prism are made of glass in Examples 4 through 6.

TABLE 10

| | | AXIAL DISTANCE | | | | |
|---|---|---|---|---|---|---|
| LENS | | BETWEEN SUR- | | | | |
| SUR- | RADIUS OF | FACES (INFINITE | | | REFRAC- | ABBE |
| FACE | CURVATURE | FOCAL POINT, mm) | | | TIVE | NUM- |
| No. | (mm) | W | M | T | INDEX | BER |
| OBJECT | — | ∞ | ∞ | ∞ | | |
| r1* | −8.591 | 7.181 | | | 1.58340 | 30.23 |
| r2* | −16.102 | 1.019 | 1.826 | 0.656 | | |
| r3 | −5.670 | 0.574 | | | 1.67603 | 54.67 |
| r4 | 5.934 | 0.008 | | | 1.51400 | 42.83 |
| r5 | 5.934 | 1.336 | | | 1.84828 | 33.62 |
| r6 | −41.351 | 5.462 | 1.713 | 0.100 | | |
| r7 | | 0.574 | | | | |
| r8 | 8.031 | 3.400 | | | 1.84666 | 23.82 |
| r9 | 3.690 | 0.008 | | | 1.51400 | 42.83 |
| r10 | 3.690 | 1.488 | | | 1.64275 | 56.36 |
| r11 | −89.291 | 0.100 | | | | |
| r12* | 3.741 | 3.393 | | | 1.51342 | 66.94 |
| r13* | 4.610 | 1.076 | 3.861 | 6.645 | | |
| r14* | 11.242 | 6.468 | | | 1.51680 | 64.20 |
| r15* | −25.187 | 0.483 | | | | |
| r16 | ∞ | 0.500 | | | 1.51680 | 64.20 |
| r17 | ∞ | 0.500 | | | | |
| r18 | ∞ | | | | | |

TABLE 11

| LENS SURFACE | CONICAL | ASPHERIC COEFFICIENT | | | | |
|---|---|---|---|---|---|---|
| No. | COEFFICIENT | A | B | C | D | E |
| r1* | 0.098636 | 1.39E−03 | −3.05E−05 | 1.65E−06 | −5.70E−08 | 8.64E−10 |
| r2* | 0 | 7.89E−04 | −5.99E−05 | 8.21E−06 | −4.19E−07 | 0.00E+00 |
| r12* | 0 | 2.59E−04 | −9.52E−05 | 1.55E−05 | −1.26E−06 | 0.00E+00 |
| r13* | 0 | 6.42E−03 | 1.61E−04 | 4.99E−05 | 6.34E−06 | 0.00E+00 |
| r14* | 0 | 1.62E−03 | −1.07E−04 | 1.34E−05 | −5.19E−07 | 0.00E+00 |
| r15* | 0 | 7.00E−03 | −3.18E−05 | −5.79E−05 | 5.71E−06 | 0.OOE+00 |

Table 10 indicates, from the left-side column thereof, the respective lens surface numbers, radii of curvature (unit: mm) of the respective lens surfaces, distances (unit: mm) between the respective lens surfaces in the optical axis direction, namely, axial distances between the respective lens surfaces in the infinite focal point at the wide angle limit (W), the mid point (M), and the telephoto limit (T), refractive indices of the respective lens elements, and the Abbe numbers of the respective lens elements. The values in the blank columns regarding the axial distance at the mid point (M) and at the telephoto limit (T) are the same as that in the corresponding left-side column at the wide angle limit (W). The axial distance is a distance calculated on the presumption that the medium residing in the region between a pair of opposing planes including an optical plane and an imaging plane is the air. As shown in FIG. 22, the surface denoted by ri (i=1, 2, 3, . . . ) indicates the i-th lens surface from the object side, and the surface ri marked with an asterisk (*) is an aspherical surface, namely, a refractive optical plane of an aspherical configuration or a plane having a refractive power substantially equivalent to the action of an aspherical plane.

As is obvious from Table 10, in Example 4, both sides of the lens element (LP1) closest to the object side, both sides of the fifth lens element (L5), and both sides of the lens element (LP2) closest to the imaging side are aspherical. Further, since the aperture stop (ST), both sides of the plane parallel plate (PL), and the light receiving surface of the image sensor (SR) are flat, respective radii of curvature thereof are infinite (∞).

The aspherical configuration of the lens element is defined by the following conditional formula (4), wherein the apex of the lens surface is represented as the point of origin, and a local orthogonal coordinate system (x, y, z), with the direction from the object toward the image sensor being the positive z-axis direction is used.

$$z = \frac{c \cdot {h}^{2}}{1 + \sqrt{1 - ( 1 + k ) {c}^{2} \cdot {h}^{2}}} + A \cdot {h}^{4} + B \cdot {h}^{6} + C \cdot {h}^{8} + D \cdot {h}^{10} + E \cdot {h}^{12} \qquad ( 4 )$$

where
z represents a z-axis displacement at the height position h relative to the apex of the lens surface,
h represents a height in a direction perpendicular to the z-axis (h²=x²+y²),
c represents a curvature near the apex of the lens surface (=1/radius of curvature),
A, B, C, D, and E respectively represent aspheric coefficients of 4th, 6th, 8th, 10th, and 12th orders, and
k represents a conical coefficient. Table 11 shows the conical coefficient k, and the aspheric coefficients A, B, C, D, and E of the respective lens surfaces. As is obvious from the conditional formula (4), the radii of curvature of the respective aspheric lens elements shown in Table 1 each show a value approximate to the center of the corresponding lens element.

The spherical aberration (LONGITUDINAL SPHERICAL ABERRATION in FIGS. 27A, 27D, and 27G), the astigmatism (ASTIGMATISM in FIGS. 27B, 27E, and 27I), and the distortion aberration (DISTORTION in FIGS. 27C, 27F, and 27I) of the optical system having the above lens arrangement and construction in Example 4, namely, the optical system comprised of the first through the fourth lens groups with an infinite focal length are shown in FIGS. 27A through 27I. Specifically, the respective aberrations at the wide angle limit (W), the mid point (M), and the telephoto limit (T) are shown in the upper row, the intermediate row, and the lower row in FIGS. 27A through 27I. Each of the horizontal axes in the spherical aberration diagrams and the astigmatism diagrams shows a focal point displacement in the unit of mm. Each of the horizontal axes in the distortion aberration diagrams shows a distortion in terms of percentage. Each of the vertical axes in the spherical aberration diagrams shows a value standardized by the incident height, and each of the vertical axes in the astigmatism diagrams and the distortion aberration diagrams shows a height of an optical image or an image height in the unit of mm.

In the spherical aberration diagrams, aberrations in case of using light of three different wavelengths are shown, wherein the one-dotted-chain lines represent aberrations in a red ray (wavelength: 656.27 nm), the solid lines represent aberrations in a yellow ray (so-called “d-ray” having a wavelength of 587.56 nm), and the broken lines represent aberrations in a blue ray (wavelength: 435.83 nm). In the astigmatism diagrams, the dashed lines “S” and “T” respectively represent results on a sagittal (radial) plane and a tangential (meridional) plane. Further, the astigmatism diagrams and the distortion aberration diagrams show results of using the yellow ray or d-ray.

As is obvious from FIGS. 27A through 27I, the lens groups in Example 4 exhibit superior optical characteristics, wherein the spherical aberration, the astigmatism, and the distortion aberration are significantly small at all the positions, namely, at the wide angle limit (W), the mid point (W), and the telephoto limit (T). The focal lengths (unit: mm) and the F-numbers at the wide angle limit (W), the mid point (M), and the telephoto limit (T) in Example 4 are shown in Table 16 and Table 17, respectively. Tables 16 and 17 show that Example 4 provides a fast optical system with a short focal length.

### Example 5

Construction data on the respective lens elements in the zoom optical system 55 as the fifth embodiment (Example 5) are described in Tables 12 and 13. As is obvious from Tables 12 and 13, in Example 5, both sides of the lens element (LP1) closest to the object side, the imaging-side surface of the second lens element (L2), the object-side surface of the third lens element (L3), both sides of the fifth lens element (L5), and both sides of the lens element (LP2) closest to the imaging side are aspherical.

TABLE 10

| | | AXIAL DISTANCE | | | | |
|---|---|---|---|---|---|---|
| LENS | | BETWEEN SUR- | | | | |
| SUR- | RADIUS OF | FACES (INFINITE | | | REFRAC- | ABBE |
| FACE | CURVATURE | FOCAL POINT, mm) | | | TIVE | NUM- |
| No. | (mm) | W | M | T | INDEX | BER |
| OBJECT | — | ∞ | ∞ | ∞ | | |
| r1* | −6.031 | 7.424 | | | 1.58340 | 30.23 |
| r2* | −5.498 | 0.741 | | | | |
| r3 | −4.923 | 0.574 | | | 1.72858 | 52.48 |
| r4 | 29.654 | 0.008 | | | 1.51400 | 42.83 |
| r5 | 29.654 | 2.347 | | | 1.84666 | 23.82 |
| r6* | −51.572 | 6.596 | 2.807 | 0.100 | | |
| r7 | ∞ | 0.574 | | | | |
| r8* | 5.564 | 2.000 | | | 1.84666 | 23.82 |
| r9 | 3.201 | 0.008 | | | 1.51400 | 42.83 |
| r10 | 3.201 | 1.627 | | | 1.51389 | 66.89 |
| r11 | −21.826 | 0.100 | 1.840 | 0.791 | | |
| r12* | 4.500 | 3.200 | | | 1.51680 | 64.20 |
| r13* | 5.154 | 2.587 | 4.637 | 8.393 | | |
| r14* | 96.914 | 6.583 | | | 1.51680 | 64.20 |
| r15* | −6.517 | 0.000 | | | | |
| r16 | ∞ | 0.500 | | | 1.51680 | 64.20 |
| r17 | ∞ | 0.500 | | | | |
| r18 | ∞ | | | | | |

TABLE 13

| LENS SURFACE | CONICAL | ASPHERIC COEFFICIENT | | | | |
|---|---|---|---|---|---|---|
| No. | COEFFICIENT | A | B | C | D | E |
| r1* | −0.599782 | 2.00E−03 | −1.02E−05 | −1.49E−06 | 7.60E−08 | −1.42E−09 |
| r2* | 0 | 2.27E−03 | −5.45E−07 | −2.58E−06 | 2.51E−08 | 0.00E+00 |
| r6* | 0 | −9.01E−04 | 2.65E−05 | −8.48E−07 | 1.81E−07 | 0.00E+00 |
| r8* | 0 | −7.51E−05 | 5.04E−05 | −1.29E−05 | 1.38E−06 | 0.00E+00 |
| r12* | 0 | 6.51E−04 | −8.51E−05 | 2.54E−05 | −1.64E−06 | 0.00E+00 |
| r13* | 0 | 4.58E−03 | −8.90E−05 | 8.22E−05 | −3.64E−06 | 0.00E+00 |
| r14* | 0 | 2.85E−04 | 1.10E−04 | −2.29E−05 | 1.52E−06 | 0.00E+00 |
| r15* | 0 | 9.83E−03 | −8.55E−04 | 4.91E−05 | −1.20E−06 | 0.00E+00 |

### Example 6

Construction data on the respective lens elements in the zoom optical system 56 as the sixth embodiment (Example 6) are described in Tables 14 and 15. As is obvious from Tables 14 and 15, in Example 6, the object-side surface of the lens element (LP1) closest to the object side, the imaging-side surface of the second lens element (L2), the object-side surface of the third lens element (L3), the object-side surface of the fifth lens element (L5), and both sides of the lens element (LP2) closest to the imaging side are aspherical.

TABLE 14

| | | AXIAL DISTANCE | | | AXIAL DISTANCE | | | | |
|---|---|---|---|---|---|---|---|---|---|
| | | BETWEEN SURFACES | | | BETWEEN SURFACES | | | | |
| LENS | RADIUS OF | (INFINITE FOCAL | | | (CLOSEST FOCAL | | | | |
| SURFACE | CURVATURE | POINT, mm) | | | POINT, mm) | | | REFRACTIVE | ABBE |
| No. | (mm) | W | M | T | W | M | T | INDEX | NUMBER |
| OBJECT | — | ∞ | ∞ | ∞ | 200 | 200 | 200 | | |
| r1* | −10.245 | 8.047 | | | | | | 1.58340 | 30.23 |
| r2 | −3.765 | 0.030 | | | | | | 1.51400 | 42.83 |
| r3 | −3.765 | 0.574 | | | | | | 1.82757 | 54.06 |
| r4 | 10.431 | 0.008 | | | | | | 1.51400 | 42.83 |
| r5 | 10.431 | 2.919 | | | | | | 1.84666 | 23.82 |
| r6* | −595.348 | 6.161 | 2.225 | 0.100 | 6.532 | 2.476 | 0.338 | | |
| r7 | ∞ | 0.574 | | | | | | | |
| r8* | 5.109 | 2.000 | | | | | | 1.84666 | 23.82 |
| r9 | 2.989 | 0.008 | | | | | | 1.51400 | 42.83 |
| r10 | 2.989 | 1.446 | | | | | | 1.54742 | 63.28 |
| r11 | −36.604 | 2.699 | 4.307 | 3.765 | 2.328 | 4.056 | 3.527 | | |
| r12* | 9.589 | 4.400 | | | | | | 1.51680 | 64.20 |
| r13 | −34.549 | 0.513 | 2.841 | 5.508 | 0.513 | 2.841 | 5.508 | | |
| r14* | 34.039 | 5.439 | | | | | | 1.51680 | 64.20 |
| r15* | 8.742 | 1.182 | | | | | | | |
| r16 | ∞ | 0.500 | | | | | | 1.51680 | 64.20 |
| r17 | ∞ | 0.500 | | | | | | | |
| r18 | ∞ | | | | | | | | |

TABLE 15

| LENS SURFACE | CONICAL | ASPHERIC COEFFICIENT | | | | |
|---|---|---|---|---|---|---|
| No. | COEFFICIENT | A | B | C | D | E |
| r1* | −0.729266 | 1.10E−03 | −1.56E−05 | 5.33E−07 | −1.75E−08 | 2.93E−10 |
| r6* | 0 | 1.25E−04 | 5.99E−05 | −1.74E−05 | 1.08E−06 | 0.00E+00 |
| r8* | 0 | −1.93E−04 | 4.85E−05 | −2.14E−05 | 3.59E−06 | 0.00E+00 |
| r12* | 0 | −1.14E−04 | 3.34E−05 | −6.98E−07 | −9.94E−09 | 0.00E+00 |
| r14* | 0 | −9.69E−04 | −3.47E−05 | −1.61E−05 | 9.67E−07 | 0.00E+00 |
| r15* | 0 | 3.49E−03 | −1.65E−04 | −2.82E−05 | 1.97E−06 | 0.00E+00 |

The spherical aberration (LONGITUDINAL SPHERICAL ABERRATION in FIGS. 28A, 28D, 28G, 29A, 29D, 29G, 30A, 30D, and 30G), the astigmatism (ASTIGMATISM in FIGS. 28B, 28E, 28H, 29B, 29E, 29H, 30B, 30E, and 30H), and the distortion aberration (DISTORTION in FIGS. 28C, 28F, 28I, 29C, 29F, 291, 30C, 30F, and 30I) of the optical systems in Examples 5 and 6 having the above lens arrangement and construction are shown in FIGS. 28A through 30I. Specifically, FIGS. 28A through 28I are aberration diagrams of Example 5 with an infinite focal length, FIGS. 29A through 29I are aberration diagrams of Example 6 with an infinite focal length, and FIGS. 30A through 30I are aberration diagrams of Example 6 with a closest focal length. As is obvious from FIGS. 28A through 30I, the lens groups in Examples 5 and 6 exhibit superior optical characteristics, wherein the spherical aberration, the astigmatism, and the distortion aberration are significantly small at all the positions, namely, at the wide angle limit (W), the mid point (W), and the telephoto limit (T).

The focal lengths (unit: mm) and the F-numbers at the wide angle limit (W), the mid point (M), and the telephoto limit (T) in Examples 5 and 6 are shown in Table 16 and Table 17, respectively. Tables 16 and 17 show that Examples 5 and 6 provide fast optical systems with a short focal length, as well as Example 4.

TABLE 16
FOCAL LENGTH (mm)

| | W | M | T |
|---|---|---|---|
| EXAMPLE 4 | 4.9 | 7.4 | 9.8 |
| EXAMPLE 5 | 4.9 | 7.4 | 10.8 |
| EXAMPLE 6 | 4.9 | 7.4 | 9.6 |

TABLE 17
F NUMBER

| | W | M | T |
|---|---|---|---|
| EXAMPLE 4 | 3.1 | 3.8 | 4.5 |
| EXAMPLE 5 | 3.3 | 4.0 | 5.0 |
| EXAMPLE 6 | 3.9 | 4.6 | 5.0 |

The arrangement relations between the second reflecting prism (PR2) and the image sensor (SR) in Examples 4 through 6 are defined as shown in Table 18 to miniaturize the respective zoom optical systems. Specifically, the height a (unit: mm) of the light receiving surface of the image sensor (SR) on the plane where the optical path of the image sensor (SR) is folded, which corresponds to the plane of FIG. 21 (FIG. 23 or FIG. 25), the distance d (unit: mm) between the exit surface (S6) of the second reflecting prism (PR2) and the light receiving surface of the image sensor (SR), and the respective calculation results of the conditional formula (1) in Examples 4 through 6 are as shown in Table 18.

TABLE 18

| | HEIGHT (a) OF LIGHT RECEIVING | DISTANCE (d) BETWEEN EXIT | |
|---|---|---|---|
| | SURFACE OF IMAGE SENSOR | SURFACE OF SECOND REFLECTING | |
| | ON PLANE WHERE OPTICAL | PRISM AND LIGHT RECEIVING | |
| | PATH IS FOLDED | SURFACE OF IMAGE SENSOR | d/a |
| EXAMPLE 4 | 3.440 | 1.484 | 0.431 |
| EXAMPLE 5 | 3.440 | 1.000 | 0.291 |
| EXAMPLE 6 | 3.440 | 2.182 | 0.634 |

parameters as shown in Table 19 are adopted to optimize the size or the length of the respective second reflecting prisms (PR2) in Examples 4 through 6. Specifically, the refractive index n of each second reflecting prism (PR2), the distance t of the principal ray, the exit pupil distance p, and the respective calculation results of the conditional formula (2) in Examples 4 through 6 are as shown in Table 19, wherein the units of the parameters t and p are mm.

TABLE 19

| | EXAMPLE 4 | EXAMPLE 5 | EXAMPLE 6 |
|---|---|---|---|
| | w (WIDE ANGLE LIMIT) | w (WIDE ANGLE LIMIT) | w (WIDE ANGLE LIMIT) |
| REFRACTIVE INDEX (n) | 1.517 | 1.517 | 1.517 |
| DISTANCE (t) OF PRINCIPAL RAY | 6.468 | 6.583 | 5.439 |
| EXIT PUPIL DISTANCE (p) | −15.560 | −85.726 | −10.440 |
| (t · n)/p | −0.631 | −0.116 | −0.790 |
| | m (MID POINT) | m (MID POINT) | m (MID POINT) |
| REFRACTIVE INDEX (n) | 1.517 | 1.517 | 1.517 |
| DISTANCE (t) OF PRINCIPAL RAY | 6.468 | 6.583 | 5.439 |
| EXIT PUPIL DISTANCE (p) | −27.400 | 81.853 | −12.609 |
| (t · n)/p | −0.358 | 0.122 | +0.654 |
| | t (TELEPHOTO LIMIT) | t (TELEPHOTO LIMIT) | t (TELEPHOTO LIMIT) |
| REFRACTIVE INDEX (n) | 1.517 | 1.517 | 1.517 |
| DISTANCE (t) OF PRINCIPAL RAY | 6.468 | 6.583 | 5.439 |
| EXIT PUPIL DISTANCE (p) | −57.010 | −41.316 | −12.772 |
| (t · n)/p | −0.172 | −0.242 | −0.646 |

Adopting the parameters as shown in Tables 18 and 19 enables to reduce the respective thicknesses of the zoom optical systems 54 through 56 in the fourth through the sixth embodiments in the direction of the arrow L′ in FIG. 21, which contributes to miniaturization of the zoom optical systems in the thickness direction thereof.

In the first through the sixth embodiments, the first reflecting prism (PR1) is made of a resin or a plastic material, and the optical devices other than the first reflecting prism (PR1) are made of glass. Examples of the invention are not limited to this. It is possible to make a first reflecting prism (PR1) and a second reflecting prism (PR2) of a plastic material, or it is possible to make a part or the entirety of the optical devices including a lens element between the first reflecting prism (PR1) and the second reflecting prism (PR2) of a plastic material, as well as the first reflecting prism (PR1) and the second reflecting prism (PR2). For instance, using a plastic lens element or plastic lens elements for zooming is advantageous in reducing a load to a lens driver. Such an arrangement contributes to further miniaturization of the entirety of the imaging lens device including a lens group and a lens driver.

As described above, since the imaging optical systems 51 through 53 and the zoom optical systems 54 through 56 in the first through the sixth embodiments are compact and lightweight, these optical systems are suitable to be mounted in a digital apparatus, particularly, in a portable apparatus such as the camera phone 200. Further, since the inventive imaging optical systems and the inventive zoom optical systems have high optical performance compatible with a high-resolution image sensor having two million pixels or more, these optical systems are superior to electronic zoom systems which require interpolation.

The invention can take the following modifications in addition to or in place of the foregoing embodiments.

(1) In the imaging optical systems and the zoom optical systems of the foregoing embodiments, it is possible to use a cam or a stepping motor in driving the respective lens groups, the aperture stop or the shutter. In the case where a moving amount of the respective lens elements is small or a lens group to be driven is relatively lightweight, it is possible to use a micro-miniature piezoelectric actuator. Such a modification enables to drive the lens groups independently of each other while reducing the size of the driving section or suppressing increase of power consumption, which contributes to further miniaturization of the digital apparatus.

(2) In the foregoing embodiments, the subject-side surface of the first reflecting prism and the imaging-side surface of the second reflecting prism are disposed apart from each other at a farthest position in the direction of the arrows A to miniaturize the optical system. Alternatively, it is possible to dispose the subject-side surface of the first reflecting prism and the imaging-side surface of the second reflecting prism at a closest position in the direction of the arrows A, namely, in a region on the same side of the first reflecting prism and the second reflecting prism.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An imaging optical system comprising:
an image sensor for receiving an optical image of a subject to convert the optical image into electrical signals;
two reflecting prisms each of which is adapted to bend incident light at a predetermined angle for reflection, wherein
an incident surface of the reflecting prism disposed on the side of the subject on an optical path, and an exit surface of the other reflecting prism are aligned substantially parallel to each other, and
the incident surface or the exit surface of said at least one of the reflecting prisms has an optical power.

2. The imaging optical system according to claim 1, wherein
the incident light is bent on the reflecting prism at about 90 degrees.

3. The imaging optical system according to claim 1, wherein
said at least one of the incident surface and the exit surface of said each of the reflecting prisms has an optical power.

4. The imaging optical system according to claim 1, further comprising an aperture stop on the side of the exit surface of the reflecting prism disposed on the subject side on the optical path, wherein
said at least the incident surface of the reflecting prism disposed on the subject side on the optical path has a negative optical power.

5. The imaging optical system according to claim 1, further comprising an optical device having an optical power on the optical path between the incident surface of the reflecting prism disposed on the subject side on the optical path, and the exit surface of the other reflecting prism, the optical device including the reflecting prism.

6. The imaging optical system according to claim 5, wherein the optical device includes a lens element or a lens group arranged between the two reflecting prisms.

7. The imaging optical system according to claim 6, wherein the lens element or the lens group is moved substantially parallel to the incident surface of the reflecting prism disposed on the subject side on the optical path for focusing.

8. The imaging optical system according to claim 6, wherein
at least the two lens groups are moved in an optical axis direction thereof for zooming.

9. The imaging optical system according to claim 1, wherein
a water absorption coefficient of a resin material constituting the reflecting prism is 0.01% or smaller.

10. An imaging lens device comprising the imaging optical system of claim 1, the imaging lens device being adapted to form the optical image of the subject on the light receiving surface of the image sensor for converting the optical image into the electrical signals.

11. An imaging optical system comprising:
a reflecting prism which reflects incident light at about 90 degrees; and
an image sensor which has a light receiving surface opposing to an exit surface of the reflecting prism, and converts an optical image of a subject into electrical signals, wherein
an arrangement relation between the exit surface of the reflecting prism and the light receiving surface of the image sensor satisfies the conditional formula (1):
0.0≦d/a<0.8 (1)
where a represents a height of the light receiving surface of the image sensor on a plane where an optical path of the imaging optical system is folded, and d represents a distance between the exit surface of the reflecting prism and the light receiving surface of the image sensor, the distance d including a physical distance in a case that an optical component is provided between the exit surface of the reflecting prism and the light receiving surface of the image sensor.

12. The imaging optical system according to claim 11, wherein
the arrangement relation between the exit surface of the reflecting prism and the light receiving surface of the image sensor satisfies the conditional formula (2):
−1.5<(t·n)/p<1.0 (2)
where n represents a refractive index of the reflecting prism, t represents a distance of a principal ray on an optical axis propagating through the reflecting prism, the distance corresponding to a thickness of the reflecting prism in an expanded state thereof, and p represents an exit pupil distance.

13. The imaging optical system according to claim 11, wherein
a plurality of the reflecting prisms each reflect the incident light at about 90 degrees, the reflecting prisms being arranged in such a manner that an incident surface of the reflecting prism disposed on the side of the subject on the optical path and an exit surface of the reflecting prism disposed on the side of the image sensor are aligned substantially parallel to each other.

14. The imaging optical system according to claim 11, wherein
the reflecting prism includes a reflecting prism disposed on the side of the subject on the optical path, and a reflecting prism disposed on the side of the image sensor.

15. The imaging optical system according to claim 14, wherein said at least one of the reflecting prisms has an optical power on at least one of an incident surface and the exit surface thereof.

16. The imaging optical system according to claim 11, further comprising an optical device having an optical power on the optical path between an incident surface of the reflecting prism disposed on the side of the subject on the optical path, and the exit surface of the other reflecting prism, the optical device including the reflecting prism.

17. The imaging optical system according to claim 16, wherein the optical device includes a lens element or a lens group arranged between the two reflecting prisms.

18. The imaging optical system according to claim 17, wherein
at least the two lens groups are moved in an optical axis direction thereof for zooming.

19. The imaging optical system according to claim 11, wherein
a water absorption coefficient of a resin material constituting the reflecting prism is 0.01% or smaller.

20. An imaging lens device comprising the imaging optical system of claim 11, the imaging lens device being adapted to form the optical image of the subject on the light receiving surface of the image sensor for converting the optical image into the electrical signals.
